(19) United States
(12) Patent Application Publication
(10) Pub. No.: US 2026/0140665 A1
(43) Pub. Date: May 21, 2026

(54) FORMAT FOR COMMANDS AND COMPLETION RECORDS USED WITH SHARED WORK QUEUE

(71) Applicant: Micron Technology, Inc., Boise, ID (US)

(72) Inventors: Pierre Labat, Campbell, CA (US); Suresh Rajgopal, San Diego, CA (US); Luca Bert, Bologna (BO) (IT); Paul Stonelake, San Jose, CA (US)

(21) Appl. No.: 19/277,273

(22) Filed: Jul. 22, 2025

Related U.S. Application Data
(60) Provisional application No. 63/722,352, filed on Nov. 19, 2024.

(51) Int. Cl. G06F 3/06

(52) U.S. Cl. CPC G06F 3/0659; G06F 3/0604; G06F 3/0679

(57) ABSTRACT

Systems, methods, and apparatus related to shared work queue interfaces for memory devices. In one approach, an NVMe solid-state drive (SSD) includes flash memory. A controller receives, from a submission queue, commands configured with a predefined field, wherein the predefined field includes a command identifier. The SSD is reconfigured so that the controller receives, in a shared work queue, commands from processes executing on a host system. Each command is configured with the same predefined field (e.g., at the same Dword location according to the NVMe 2.0 specification), but the predefined field is repurposed so that its content includes at least a portion of an identifier for an address space (e.g., PASID) of the host system used by the process. Each command also may include a completion address and a phase bit.

### RELATED APPLICATIONS

The present application claims priority to U.S. Prov. Pat. App. Ser. No. 63/722,352 filed Nov. 19, 2024, the entire disclosure of which application is hereby incorporated herein by reference.

### TECHNICAL FIELD

At least some embodiments disclosed herein relate to memory systems in general, and more particularly, but not limited to formats for commands and completion records used in memory systems having a shared work queue.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 illustrates an example computing system having a host system and a memory sub-system configured in accordance with some embodiments of the present disclosure.

FIG. 2 shows a memory sub-system having multiple shared work queues to receive commands from a host system according to one embodiment.

FIG. 3 shows a memory sub-system having a shared work queue that uses slots to receive work requests from a host system according to one embodiment.

FIG. 4 shows a memory sub-system having multiple shared work queues with each shared work queue receiving commands from one of multiple threads executing in a host system according to one embodiment.

FIG. 5 shows an access command configuration according to one embodiment.

FIG. 6 shows a method for sending commands to a shared work queue of a memory sub-system according to one embodiment.

FIG. 7 shows a memory sub-system having shared work queues to receive commands with an address for a completion record according to one embodiment.

FIG. 8 shows a memory sub-system having a shared work queue that uses slots to receive commands each including a completion address according to one embodiment.

FIG. 9 shows a command configuration including a completion address according to one embodiment.

FIG. 10 shows a method for generating completion records for sending to a completion address specified by commands received in a shared work queue according to one embodiment.

FIG. 11 shows a memory sub-system having multiple shared work queues to receive commands including an address space identifier according to one embodiment.

FIG. 12 shows a memory sub-system having multiple shared work queues to receive commands from processes executing on a host system to train one or more neural networks according to one embodiment.

FIG. 13 shows a memory sub-system having a shared work queue to receive commands including an address space identifier used by a direct memory access (DMA) engine to perform data transfer corresponding to the commands according to one embodiment.

FIG. 14 shows a command configuration including an address space identifier according to one embodiment.

FIG. 15 shows a method for performing direct memory access (DMA) data transfers using address space identifiers specified by commands received in a shared work queue according to one embodiment.

FIG. 16 shows a memory sub-system that can receive commands either from a submission queue of a host system or in a shared work queue of the memory sub-system according to one embodiment.

FIG. 17 shows a format of commands received via a submission queue of a legacy system.

FIG. 18 shows a format of commands received in a shared work queue according to one embodiment.

FIG. 19 shows a format of completion records generated for commands received via a submission queue of a legacy system.

FIG. 20 shows a format of completion records generated for commands received in a shared work queue according to one embodiment.

FIG. 21 shows a method for executing a command to access a non-volatile memory device and generating a completion record according to one embodiment.

FIG. 22 is a block diagram of an example computer system in which embodiments of the present disclosure can operate.

### DETAILED DESCRIPTION

At least some aspects of the present disclosure are directed to techniques for sending commands from a host system to a shared work queue (sometimes indicated as an SWQ) of a memory sub-system. For example, the memory sub-system is accessed by the host system using the commands. For example, the commands can specify read or write operations that access one or more non-volatile memory devices of the memory sub-system. The commands are loaded from the shared work queue to an internal command queue of the memory sub-system to execute the read or write operations.

A conventional memory sub-system (e.g., a solid-state drive in compliance with a non-volatile memory express (NVMe) standard) can include a flash memory (e.g., NAND memory) that is to be in an erased state before being programmed to store data. For example, such a flash memory can include memory cells formed in an integrated circuit die and structured in pages of memory cells, blocks of pages, and planes of blocks. A page of memory cells is configured to be programmed together to store data in an atomic operation of programming memory cells. A block of memory cells can have a plurality of pages, which are configured to be erased together in an atomic operation of erasing memory cells. It is not operable to perform an operation to erase some pages in a block without erasing other pages in the same block. However, the pages in a block can be programmed separately. A plane of memory cells can have a plurality of blocks. In some implementations, planes of memory cells have the same structure such that a same operation (e.g., read, write) can be performed in parallel in multiple planes.

A conventional host system is configured (e.g., according to an NVMe standard) to instruct the memory sub-system to store data at locations specified via logical block addresses (e.g., LBA addresses). Each logical block address identifies a block of storage space that can be implemented using the storage capacity of one or more pages of memory cells. For example, a typical size of the storage space represented by a logical block address in a solid-state drive (SSD) is 512 bytes (or larger, e.g., 4 KB). The memory sub-system (e.g., SSD) can have a flash translation layer configured to map the logical block addresses as known to the host system to physical addresses of memory cells in the memory sub-system. As a result, the host system does not have to be aware which data items are stored in which particular memory cells.

A conventional NVMe solid-state drive (SSD) can receive commands from a host system via a submission queue and provide completion records about execution of the commands in a completion queue (sometimes referred to as a queue pair (QP)). The host can write to a doorbell register in the SSD to cause the SSD to poll submission queues for commands.

In a typical NVMe implementation, processors (e.g., CPU, GPU, AI accelerators) communicate over a PCIe bus with an SSD via random access memory/main memory of the processor. For example, a pair of message queues in the memory can be used for a processor to send commands to the SSD in the submission queue, and for the SSD to send completion records to the processor in the completion queue.

Each submission queue is a circular queue having slots of the same size. Each slot in a submission queue holds one command for execution by the SSD. Each slot in the completion queue holds a completion record about the execution of a command.

When a processor enters a command in a submission queue configured in the main memory, all related activity occurs within the host system (e.g., the processor and its main memory/random access memory). The SSD is not aware that the processor has entered the command in the submission queue. Instead, the SSD may periodically read the submission queue determine if new commands have been entered. Alternatively, that SSD may have a doorbell register. The processor writes to the doorbell register to notify the SSD to check the submission queue.

In the NVMe standard, the SSD typically reads/writes data in blocks of 512 bytes or more (4 KB is recommended). The NVMe protocol implements certain features for communications between processors and the SSD using access to random access memory. An NVMe command can include various information about operations to be performed (e.g., read or write), a location in a storage space in the SSD for performing the operation, a location in the main memory to store the retrieved data for a read, or a location in the main memory to retrieve the data to be written into the SSD.

As SSDs have increased in speed, more recent systems use an SSD as secondary memory in AI applications. For example, many GPU cores/threads may have parallel requests to the SSD for such applications. It can be advantageous to use one queue pair (a pair of submission queue and completion queue) for each thread. However, AI applications in some cases can have a very large number of parallel threads (e.g., thousands or more). But, for example, a typical SSD is limited to handling only 1024 submission queues (e.g., because of the hardware/controller used in the SSD). As a result, the host needs to run software to combine commands from multiple threads into a single submission queue. This can cause inefficiencies due to synchronization required for handling the combination of commands from these threads.

In one example, an NVMe interface is used for communication between a GPU or other host on one side of a connection fabric (e.g., PCIe fabric) and an NVMe SSD on the other side of the connection fabric. This interface is used by the GPU or host to send NVMe commands to the SSD and to receive NVMe command completions.

For example, the NVMe interface passes NVMe commands and gets completions as described in NVMe spec 2.0 (sometimes referred to herein as a legacy interface). This interface uses NVMe Submission Queues, Completion Queues, and NVMe doorbells. This legacy interface was designed for use cases in which the number of threads is fairly limited. However, as mentioned above, new use cases having large numbers of threads are emerging for which this legacy interface is not efficient. Thus, there is a need for an improved NVMe interface to cope more efficiently with these new use cases.

In one example of a legacy NVMe use case, threads running in a host operating system (OS) issue NVMe commands. These OS threads (e.g., 100-900 threads) are factored on host logical CPUs (sometimes referred to herein as LCPUs) with one queue pair (QP) associated to each logical CPU. This is done because OS threads are scheduled one at a time on an LCPU.

Even if there are thousands or more OS threads doing input/output operations (IOs) on a host server, only a few hundred (number of host LCPUs) actually access QPs at the same time. This limitation exists because at any given time, only one thread can run on a given LCPU.

Because the QP associated to the LCPU is updated by one thread at a time (the one currently running on the LCPU), there is no need for synchronization between threads regarding QP updates. However, the QP update is typically enclosed by synchronization code to handle the rare situation of one or more LCPUs being removed. This synchronization code doesn't generate significant overhead.

The synchronization is typically implemented via an atomic variable, one per QP. A test-and-set operation is done on that atomic variable. For example, the atomic variable AVi for QPi stays in the L1 cache of LCPUi associated to QPi. A thread running on LCPUj accesses only AVj and never AVi. Consequently, the atomic variable stays exclusive in the L1 cache, and modifying the atomic variable requires about one clock cycle.

An NVMe Completion Queue of a QP is polled by only one thread at a time, running on the LCPU associated to the QP. Hence, the most likely situation for the submission queue (SQ) is that there is no need of synchronization. For this use case, the legacy NVMe interface typically operates satisfactorily.

However, as mentioned above, there are new emerging NVMe use cases in which a processor (e.g., a GPU) issues a large number of NVMe commands. For example, in these use cases hundreds of thousands of GPU threads can access the NVMe QPs simultaneously. This is significantly more than the number of threads for the few hundreds of LCPUs of the legacy use case above.

The thread synchronization required above presents a technical problem that induces significant GPU overhead when queuing NVMe commands and getting their completion status. This overhead is incurred by the threads on the GPU when the threads synchronize the access to NVMe submission queues (SQs) and completion queues (CQs). Implementing this synchronization code robs processing cycles and/or resources from the GPU (e.g., a Streaming Multiprocessor (SM) of the GPU).

Now discussing this increased overhead need in more detail, on an NVIDIA GPU, for example, threads run on Streaming Multiprocessors. A GPU contains typically between one and two hundred SMs. Each SM typically runs 2048 threads in parallel.

Similarly to the legacy NVMe use case above, it can be desirable to have only one thread at a time using a QP. In such case, there could be a need, for example, for several hundred thousand NVMe QPs. Each QP would have one or very few NVMe commands (and most of the time typically only one command) queued in the QP submission queue. The creation of these QPs would be time-consuming, and these QPs would waste a lot of SSD hardware resources.

Having a limited number of NVMe QPs available, one can consider how the use of the QPs might potentially be optimized in the above GPU use case. Noting that all threads running on a same Streaming Multiprocessor (SM) share the same L1 cache, an efficient use of NVMe QPs is to use one QP per SM. Any thread running on the SM can use the QP associated to the SM. Doing so guarantees that the serialization atomic variables (e.g., used to serialize access to the QP across threads running in parallel on the SM, one set of atomic variables per QP) and the QP itself stays in the SM L1 cache. No other thread running on another SM is going to access the QP.

When contention happens (e.g., several threads running on the same SM post in the SQ or read the CQ), the contention is handled in the SM L1 cache, and there is no need to access the GPU main memory. This reduces SM thread stalls (e.g., cache miss is avoided) by handling the contention in L1 cache, and also reduces the usage of memory bandwidth.

However, the above approach still has significant limitations. Specifically, the threads running on a same SM must wait in turn to access the QP, one after the other. The threads wait by looping doing atomic operations on the QP atomic variables, to know when it is a thread's turn to access the QP. This creates undesirable SM overhead.

In some approaches, a part of the queueing can be done in the same SQ in parallel (e.g., writing NVMe commands in parallel in different entries of the SQ). But these approaches themselves also require the use of atomic variables. Some parts of the queuing cannot be done in parallel. For example, the SQ doorbell update and ensuring that SQ content is consistent with the doorbell value must still be serialized. For completion queues (CQs), memory atomic operations are used again to synchronize several SM threads reading the CQ associated to the SM.

Thus, even if attempts were made to improve queuing by assigning QP(s) per SM (e.g., atomic memory variables used for synchronization stay in L1, and contention is reduced to intra SM) and writing is done in parallel in SQ entries, there is still undesirable overhead having the SM use atomic memory operations (e.g., in particular at high frequencies).

At least some techniques provided in the present disclosure address the above and other deficiencies and challenges by providing a shared work queue (SWQ) interface that can be used instead of the queue pair/doorbell interface of current NVMe systems (e.g., the legacy use case above). The SWQ interface allows a processor (e.g., GPU) to write commands directly into a memory in an SSD over a PCIe bus. This effectively functions both as ringing the doorbell for immediate action, and for delivery of commands for execution. In response to receiving the commands, the SSD copies the commands to its internal command queue. For example, the processor can be a GPU Streaming Multiprocessor (e.g., NVIDIA GPU), a host core, or other similar physical processing unit running code that issues NVMe commands.

In one embodiment, to improve performance in new use cases of SSD (e.g., GPU using SSD as BAM), a shared work queue (SWQ) can be implemented in an SSD to communicate commands to SSDs without using a queue pair (QP) (a submission queue and a completion queue) and without using the doorbell register.

An SSD can expose a portion of its memory (e.g., a range in the PCIe BAR address space) to the host for access as an SWQ. The exposed memory is organized in slots. Each slot has a predetermined size (e.g., 64 bytes) for a command that can be communicated using a single transaction layer packet (TLP) over a PCIe connection. Each slot is configured to specify one command for execution by the SSD.

In response to the SWQ being written into, the SSD immediately copies the commands provided in the SWQ to the internal command queue of the SSD and thus frees the SWQ for receiving further commands. In one embodiment, the execution of the commands copied from the SWQ to the internal command queue can be similar to the execution of commands retrieved by the SSD from a submission queue into the internal command queue.

In one embodiment, an SSD stores data in NAND flash memory. The SSD uses a shared work queue to receive NVMe commands. A controller of the SSD exposes to a host system a portion of memory that is allocated to provide the SWQ. The controller receives, in the shared work queue, the command from the host system. In response to receiving the command, the controller copies the command to an internal command queue of the SSD. The commands in the internal command queue are executed to access the flash memory according to an operation (e.g., read or write) identified in the command.

In one embodiment, a memory sub-system stores data in non-volatile memory cells. A controller of an SSD receives, in a shared work queue, work requests from a host system. The shared work queue is implemented to have multiple slots each of a fixed size. Each slot receives a work request from the host system. For example, each work request includes an access command. In response to receiving each work request, the controller executes the corresponding access command in the received work request to perform an operation on the non-volatile memory cells.

In one embodiment, an SSD includes at least one non-volatile memory device and one or more controllers. The SSD stores data for a host system on which a plurality of threads execute for training a neural network(s). The SSD manages multiple SWQs. Each thread is associated with a respective one of the shared work queues. The controllers receive, in a first SWQ of the multiple SWQs, a first NVMe command from the host system. In response to receiving the first command, the SSD performs an operation on the non-volatile memory device. The operation (e.g., read or write) is specified by the first command.

In one embodiment, a memory sub-system (e.g., an NVMe device) is configured to provide access to a host system. The host system can read/write the NVMe device using an NVMe block command set based on addressing in a block namespace, where the full LBA block of data is transmitted across the PCIe bus for read or write. In one embodiment, the techniques of using the shared work queue interface have the advantages of being compatible with the NVMe specifications (e.g., NVMe base specification version 2.0). An NVMe device also can be configured to communicate to host systems that a shared work queue is supported.

In one example, a read and write can be performed using an NVMe memory namespace command set. An NVMe device can be configured to perform a read operation to retrieve the data from a set of memory cells allocated as the storage resources of an LBA block.

Various advantages are provided by at least some embodiments described herein. For example, use of the SWQ interface eliminates the need for synchronization (e.g., on the GPU) when queuing NVMe commands to the SSD and when reading command completions. For example, this eliminates the overhead incurred by the core or thread (e.g., Streaming Multiprocessor (SM)) doing this synchronization. Also, the synchronization code can be removed, which reduces maintenance cost and improves reliability.

For example, GPU overhead is reduced when the GPU queues NVMe commands and gets their completion. When a thread executing on the GPU queues an NVMe command, the thread can simply invoke a store instruction (e.g., QS instruction). The thread does not need to synchronize with other threads, check to see if the queue is full, copy the entry in a slot of the queue, and/or handle doorbells.

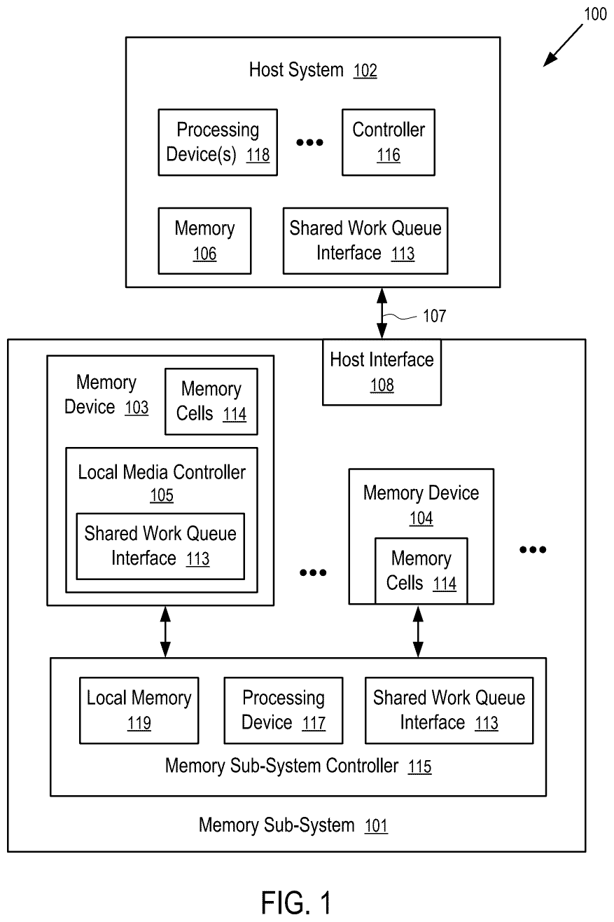

FIG. 1 illustrates an example computing system 100 that includes a memory sub-system 101 in accordance with some embodiments of the present disclosure. The memory sub-system 101 can include media, such as one or more volatile memory devices (e.g., memory device 104), one or more non-volatile memory devices (e.g., memory device 103), or a combination of such.

In general, a memory sub-system 101 can be a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, a laptop computer, a network server, a mobile device, a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

The computing system 100 can include a host system 102 that is coupled to one or more memory sub-systems 101. FIG. 1 illustrates one example of a host system 102 coupled to one memory sub-system 101. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

For example, the host system 102 can include a processor chipset (e.g., processing device 118) and a software stack executed by the processor chipset. The processor chipset can include one or more cores, one or more caches, a memory controller (e.g., controller 116) (e.g., NVDIMM controller), and a storage protocol controller (e.g., PCIe controller, SATA controller). The host system 102 uses the memory sub-system 101, for example, to write data to the memory sub-system 101 and read data from the memory sub-system 101.

The host system 102 can be coupled (e.g., over a computer bus 107) to the memory sub-system 101 via a physical host interface 108. Examples of a physical host interface 108 include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, a compute express link (CXL) interface, or any other interface. The physical host interface 108 can be used to transmit data between the host system 102 and the memory sub-system 101. The host system 102 can further utilize an NVM express (NVMe) interface to access components (e.g., memory devices 103) when the memory sub-system 101 is coupled with the host system 102 by the PCIe interface. The physical host interface 108 can provide an interface for passing control, address, data, and other signals between the memory sub-system 101 and the host system 102. FIG. 1 illustrates a memory sub-system 101 as an example. In general, the host system 102 can access multiple memory sub-systems via a same communication connection, multiple separate communication connections, and/or a combination of communication connections.

The processing device 118 of the host system 102 can be, for example, a microprocessor, a central processing unit (CPU), a processing core of a processor, an execution unit, etc. In some instances, the controller 116 can be referred to as a memory controller, a memory management unit, and/or an initiator. In one example, the controller 116 controls the communications over a bus coupled between the host system 102 and the memory sub-system 101. In general, the controller 116 can send commands or requests to the memory sub-system 101 for desired access to memory devices 103, 104. The controller 116 can further include interface circuitry to communicate with the memory sub-system 101. The interface circuitry can convert responses received from the memory sub-system 101 into information for the host system 102.

The controller 116 of the host system 102 can communicate with the controller 115 of the memory sub-system 101 to perform operations such as reading data, writing data, or erasing data at the memory devices 103, 104 and other such operations. In some instances, the controller 116 is integrated within the same package of the processing device 118. In other instances, the controller 116 is separate from the package of the processing device 118. The controller 116 and/or the processing device 118 can include hardware such as one or more integrated circuits (ICs) and/or discrete components, a buffer memory, a cache memory, or a combination thereof. The controller 116 and/or the processing device 118 can be a microcontroller, special purpose logic circuitry (e.g., a field programmable gate array (FPGA), an application specific integrated circuit (ASIC), etc.), or another suitable processor.

The memory devices 103, 104 can include any combination of the different types of non-volatile memory components and/or volatile memory components. The volatile memory devices (e.g., memory device 104) can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 103 can include one or more arrays of memory cells 114. One type of memory cells, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 103 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, and/or a PLC portion of memory cells. The memory cells 114 of the memory devices 103 can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device 103 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 115 (or controller 115 for simplicity) can communicate with the memory devices 103 to perform operations such as reading data, writing data, or erasing data at the memory devices 103 and other such operations (e.g., in response to commands scheduled on a command bus by controller 116). The controller 115 can include hardware such as one or more integrated circuits (ICs) and/or discrete components, a buffer memory, or a combination thereof. The hardware can include digital circuitry with dedicated (i.e., hard-coded) logic to perform the operations described herein. The controller 115 can be a microcontroller, special purpose logic circuitry (e.g., a field programmable gate array (FPGA), an application specific integrated circuit (ASIC), etc.), or another suitable processor.

The controller 115 can include a processing device 117 (processor) configured to execute instructions stored in a local memory 119. In the illustrated example, the local memory 119 of the controller 115 includes an embedded memory configured to store instructions for performing various processes, operations, logic flows, and routines that control operation of the memory sub-system 101, including handling communications between the memory sub-system 101 and the host system 102.

In some embodiments, the local memory 119 can include memory registers storing memory pointers, fetched data, etc. The local memory 119 can also include read-only memory (ROM) for storing micro-code. While the example memory sub-system 101 in FIG. 1 has been illustrated as including the controller 115, in another embodiment of the present disclosure, a memory sub-system 101 does not include a controller 115, and can instead rely upon external control (e.g., provided by an external host, or by a processor or controller separate from the memory sub-system).

In general, the controller 115 can receive commands or operations from the host system 102 and can convert the commands or operations into instructions or appropriate commands to achieve the desired access to the memory devices 103. The controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 103. The controller 115 can further include host interface circuitry to communicate with the host system 102 via the physical host interface 108. The host interface circuitry can convert the commands received from the host system into command instructions to access the memory devices 103 as well as convert responses associated with the memory devices 103 into information for the host system 102.

The memory sub-system 101 can also include additional circuitry or components that are not illustrated. In some embodiments, the memory sub-system 101 can include a cache or buffer (e.g., DRAM) and address circuitry (e.g., a row decoder and a column decoder) that can receive an address from the controller 115 and decode the address to access the memory devices 103.

In some embodiments, the memory devices 103 include local media controllers 105 that operate in conjunction with the memory sub-system controller 115 to execute operations on one or more memory cells of the memory devices 103. An external controller (e.g., memory sub-system controller 115) can externally manage the memory device 103 (e.g., perform media management operations on the memory device 103). In some embodiments, a memory device 103 is a managed memory device, which is a raw memory device combined with a local controller (e.g., local media controller 105) for media management within the same memory device package. An example of a managed memory device is a managed NAND (MNAND) device.

The controller 115 and/or a memory device 103 can include a shared work queue interface 113 (e.g., an SWQ as described above) configured to receive commands (e.g., access commands) from one or more host systems 102. In various embodiments, the shared work queue interface 113 provides an interface used to exchange input/output (IO) commands and completions between a host system (e.g., a GPU) and a memory sub-system (e.g., an NVMe SSD).

In some embodiments, the controller 115 in the memory sub-system 101 includes at least a portion of the shared work queue interface 113. In other embodiments, or in combination, the controller 116 and/or the processing device 118 in the host system 102 includes at least a portion of the shared work queue interface 113. For example, the controller 115, the controller 116, and/or the processing device 118 can include logic circuitry implementing the shared work queue interface 113. For example, the controller 115, or the processing device 118 (processor) of the host system 102, can be configured to execute instructions stored in memory for performing the operations of the shared work queue interface 113 described herein. In some embodiments, the shared work queue interface 113 is implemented in an integrated circuit chip disposed in the memory sub-system 101. In other embodiments, the shared work queue interface 113 can be part of firmware of the memory sub-system 101, an operating system of the host system 102, a device driver, or an application, or any combination therein.

For example, the shared work queue interface 113 implemented in the controller 115 and/or 105 of the memory sub-system 101 can be configured to expose a portion of memory for use as an SWQ. Host system 102 sends commands to the SWQ over a PCIe fabric. Controller 115 executes the commands (e.g., NVMe commands) to access memory device 103. Controller 115 indicates completion of the commands to host system 102 by sending signals over the PCIe fabric.

In one example, managers in the host system 102 and in the memory sub-system 101 are configured to establish namespaces. For example, the namespace can be an NVMe block namespace. The smallest unit of storage space accessible in the namespace is a block represented by a respective address defined in the namespace to represent the block. For example, the storage size of a block can be 512 bytes or more (e.g., 4096 bytes). A set of physical storage resources (e.g., memory cells 114) are allocated to implement the physical storage space represented by the namespace.

In one example, memory sub-system 101 is configured to access a region of storage locations. Host system 102 can use a protocol (e.g., a NVMe block command set) to send an access request to an SWQ. The access request is directed to an address in a namespace; and the memory sub-system 101 can provide a corresponding response using the protocol.

For example, the access request sent to the SWQ can be a read command. The memory sub-system 101 can execute the read command and determine the storage resource allocated to implement a logical block having the address defined in the namespace. The memory sub-system 101 then retrieves a data block from the storage resource, and sends the data block across the computer bus 107 to the memory 106 of the host system 102, as instructed by the access request according to the protocol.

For example, the access request sent to the SWQ can be a write command. The memory sub-system 101 can use an address map to determine a storage resource block allocated to implement a logical block having the address defined in the namespace. After retrieving the data block from the memory 106 of the host system 102, as instructed by the access request according to the protocol, the memory sub-system 101 can program the storage resource block to store the data block obtained from the memory 106 of the host system 102.

Further details of the operations of the shared work queue interface(s) 113 in the host system 102 and in the memory sub-system 101 are discussed below.

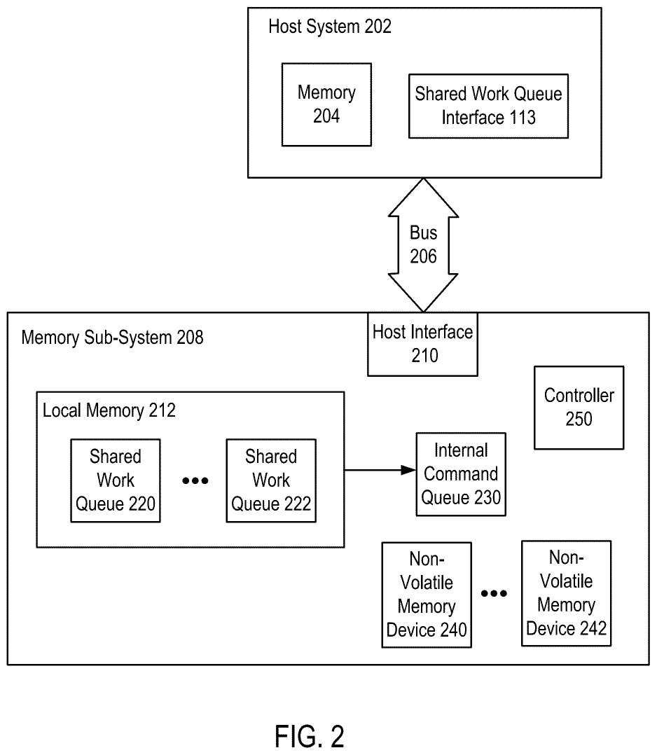

FIG. 2 shows a memory sub-system 208 having multiple shared work queues 220, 222 to receive commands from a host system 202 according to one embodiment. Host system 202 sends commands to memory sub-system 208 using bus 206.

Host system 202 is an example of host system 102. Memory sub-system 208 is an example of memory sub-system 101. Bus 206 is, for example, a computer bus 107 operated according to the PCIe protocol.

Physical host interface 210 passes commands from host system 202 to one of the shared work queues. Controller 250 exposes a portion of local memory 212 to permit access by host system 202 to shared work queues 220, 222. When a command is received by one of the shared work queues, controller 250 copies the commands into internal command queue 230. Controller 250 manages the ordering of commands in queue 230 for executing various operations, including accessing non-volatile memory devices 240, 242. The operations include read and write operations.

In one embodiment, shared work queue interface 113 at host system 202 manages the collection and sending of commands to one or more of shared work queues 220, 222. In one embodiment, each command indicates a logical address of a storage space in memory sub-system 208.

In one embodiment, memory 204 is main memory used by one or more processors of host system 202. Each command (e.g., an NVMe command) indicates a location in memory 204 from which data is read for storage in a memory device 240, 242, and/or a location in memory 204 to which data is written after being retrieved from a memory device 240, 242. In one embodiment, memory 204 is accessed by controller 250 using a direct memory access (DMA) protocol.

In one example, access to shared work queue 220 is provided by exposing a range of addresses of local memory 212 to host system 202. In one example, the range of addresses is exposed via a base address register (BAR).

In one example, each command specifies an LBA address from which data is retrieved. The retrieved data is transferred to a memory address of memory 204 that is specified in the command.

In one example, each command is configured according to a non-volatile memory express (NVMe) standard. Main memory 204 is used to communicate between a processor at host system 202 and an SSD 208. Each NVMe command indicates one or more functions to be performed by the SSD (e.g., to read from a storage space of the SSD, to write to the storage space, etc.). The processor identifies read/write locations in the commands using logical block addressing (LBA) addresses. The SSD has a flash translation layer to map/translate the LBA addresses to physical addresses in flash memory of the SSD.

For example, each NVMe command further includes information about the location in the storage space for the operation, a location in main memory 204 to store the retrieved data for a read, and/or a location in main memory 204 to retrieve the data to be written into the SSD. Bus 260 is a PCIe bus/physical connection used for accessing memory. The SSD accesses main memory 204 over the PCIe bus. The SSD exposes a portion of its memory (e.g., local memory 212) to allow a processor of host system 202 to access the exposed portion over the PCIe bus.

In one embodiment, an address for each shared work queue 220, 222 is provided to host system 202. For example, a processor of host system 202 writes commands to the address of the shared work queue. In one example, this writing is done using a PCIe protocol (sometimes referred to as a PCIe memory write (MWr or DMWr)).

In some embodiments, a single shared work queue 220 is used for each controller 250. In other embodiments, multiple shared work queues can be used for each controller. In one example, multiple shared work queues are used to provide quality of service (QoS) functionality.

In one embodiment, memory sub-system 208 is configured to selectively enable or disable a shared work queue interface. In some cases, the memory sub-system 208 uses a legacy NVMe interface to send to all admin NVMe commands. The legacy NVMe interface also can be used to send certain IO NVMe commands that cannot be sent using an SWQ.

In one embodiment, memory sub-system 208 is an NVMe SSD. The NVMe SSD implements the legacy interface using QPs as defined in the NVMe specification 2.0. The admin commands use the legacy interface. The NVMe SSD can be configured to use the legacy interface and/or the shared work queue interface for NVMe IO commands. It is not required to have both interfaces enabled simultaneously.

In one example, the NVMe SSD exposes one or several NVMe shared work queues (SWQs) to a host (e.g., 202). For example, the SWQ is a range of addresses in the NVMe PCIe device memory exposed to the host via a BAR register.

In one example, the size of the SWQ is a multiple of 64 bytes or other fixed number of bytes. For example, each 64 bytes of the SWQ is implemented as a slot to receive a 64 B work request from the host. Each work request contains one NVMe command. The host or GPU writes an NVMe command in a SWQ slot to send the command to the SSD. Each 64 B write of a work request is guaranteed to be delivered to the NVMe SSD in a single PCIe TLP.

In typical embodiments, the shared work queue interface does not have a completion queue. Instead, to handle completion, the NVMe SSD writes the command completion record at an address provided in the NVMe command from the host.

In one embodiment, the shared work queue interface supports only completion polling (no interrupts). There is no NVMe doorbell used in the shared work queue interface.

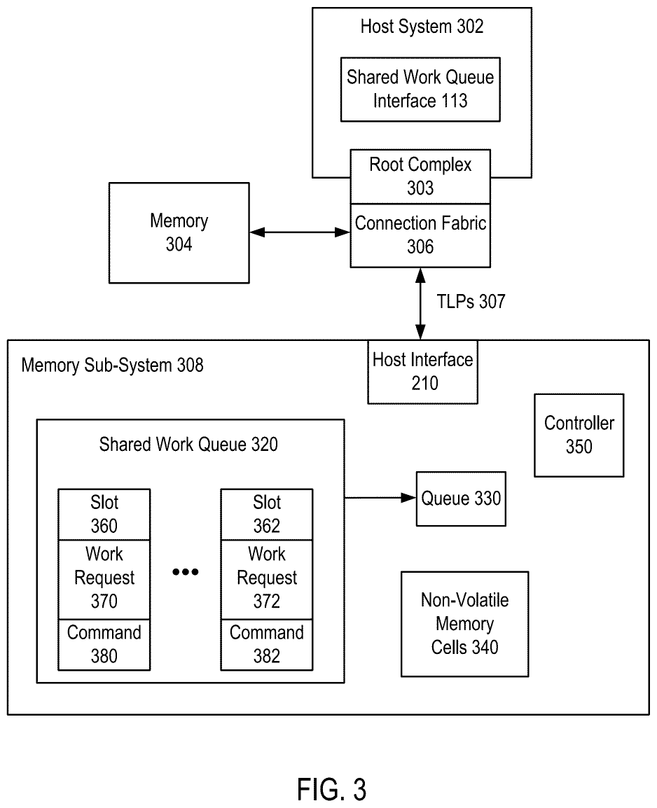

FIG. 3 shows a memory sub-system 308 having a shared work queue 320 that uses slots 360, 362 to receive work requests from a host system 302 according to one embodiment. Memory sub-system 308 is an example of memory sub-system 101. Host system 302 is an example of host system 102. In one example, shared work queue 320 is similar to shared work queue 220.

Host system 302 and memory sub-system 308 communicate over a connection fabric 306. In one example, connection fabric 306 is a PCIe fabric. Connection fabric 306 includes a root complex 303. For example, root complex 303 can be implemented by hardware of host system 302, or can be implemented on a separate chip.

Connection fabric 306 also enables host system 302 and memory sub-system 308 to access memory 304. In one example, memory 304 is main memory of host system 302. In one example, controller 350 performs direct memory access (DMA) operations on memory 304 in response to commands received from host system 302.

In one embodiment, host system 302 sends commands to shared work queue 320 using transaction layer packets 307 (e.g., TLPs according to a PCIe protocol). Each TLP 307 can include a command. In one example, the command is included as part of a work request encapsulated by TLP 307.

In one embodiment, shared work queue interface 113 of host system 302 generates and sends work requests 370, 372 to shared work queue 320. Controller 350 receives each work request into one of slots 360, 362. Controller 350 extracts commands 380, 382 from the work requests and copies the commands into queue 330 for execution. Each command indicates an operation that controller 350 performs on non-volatile memory cells 340.

In one embodiment, controller 350 copies commands to queue 330 in response to receiving a transaction layer packet targeted to the shared work queue 320. In one embodiment, the command(s) of the TLP 307 are stored in command queue 330 without any dependency on other transaction layer packets received from the host system.

In one embodiment, the slots 360, 362 of the shared work queue 320 are each of a fixed size. The root complex 303 of the connection fabric 306 commits each TLP aligned on a boundary having a fixed size in bytes. Each TLP has a data payload that is equal to or a multiple of the fixed size. The data payload includes, for example, a work request sent from a thread executing on the host system.

In one embodiment, multiple work requests can be delivered to the memory sub-system using a single transaction layer packet. In one embodiment, the host system invokes a store instruction to queue each work request.

In one example, connection fabric 306 includes a PCIe bus acting as a bridge connecting a host system and an SSD. When the host system writes to memory in the SSD over the PCIe bus, PCIe TLPs are used. When the SSD reads or writes memory on the host side (e.g., to access main memory 304 when executing NVMe commands received in an SWQ, to retrieve commands for a submission queue (e.g., residing in memory 304), or to enter a completion record in a completion queue (e.g., residing in memory 304)), the SSD also uses PCIe TLPs.

In one embodiment, shared work queue 320 has a size that is a multiple of a fixed size unit (e.g., a unit of 64 bytes). SWQ 320 is defined as a range in a PCIe BAR address space. For example, SWQ 320 is 64 bytes aligned, and the SWQ size is a multiple of 64 B.

In one embodiment, shared work queue 320 has multiple slots 360, 362. Each slot has a predetermined fixed size. Each slot receives a work request 370, 372. Each work request has a size that matches the size of the slot. In one example, work request 370 includes read command 380. In one example, work request 372 includes write command 382. In one example, each work request is sent as a data payload of a TLP 307. In one example, a data payload of a TLP includes multiple work requests, each having the same size.

In one example, memory sub-system 308 is an NVMe SSD. When the SSD receives a write TLP targeted to SWQ 320, controller 350 immediately copies the data payload of the TLP (e.g., data payload having one or several 64 B NVMe commands) into internal queue 330. The NVMe commands are processed by the SSD from internal queue 330.

In some cases, the internal queue 330 may be full when the host system 302 pushes NVMe commands at a rate exceeding the maximum input/output operations (IOPs) supported by the SSD. If the internal queue is full, the SSD can signal the host system (e.g., by sending a retry signal). Alternatively, the SSD can regulate credits provided to the host system for memory writes.

In one embodiment, NVMe commands copied from SWQ 320 to internal queue 330 are processed by memory sub-system 308 in the same way as for NVMe commands copied from a legacy use case submission queue to internal queue 330.

As mentioned above, shared work queue 320 can have a size that is a multiple of a fixed size unit (e.g., a unit of 64 bytes). For example, the size can be as small as 64 B. In some cases, use of a size of SWQ larger than 64 B can help to reduce the TLP header overhead. For example, if the SWQ size is 128 B, then two NVMe commands can be sent in one TLP 307 as opposed to two TLPs with a 64 B SWQ size.

It is noted that a larger SWQ size may be beneficial only if connection fabric 306 (e.g., PCIe fabric) is configured not to break TLPs 307 with a data payload size equal to the larger SWQ size. In one example, in the case that an NVMe SSD exposes large-sized SWQs and the PCIe fabric allows only for a TLP with a data payload smaller than the SWQ size, alignment problems are avoided because each TLP has a data payload multiple of 64 B aligned on a 64 B boundary. Consequently, when receiving a TLP targeted to one SWQ, the NVMe SSD can store the NVMe commands present in the TLP immediately in the NVMe SSD internal queue 330 without any dependency on other TLPs.

In one example, root complex 303 emits TLPs 307 (e.g., using deferred memory write (DMWr) or memory write (MWr)). Each TLP 307 is aligned on 64 B boundary with a data payload multiple of 64 B. If the TLP is split by a switch of connection fabric 306, the split is done on a 64 B boundary (and nothing smaller).

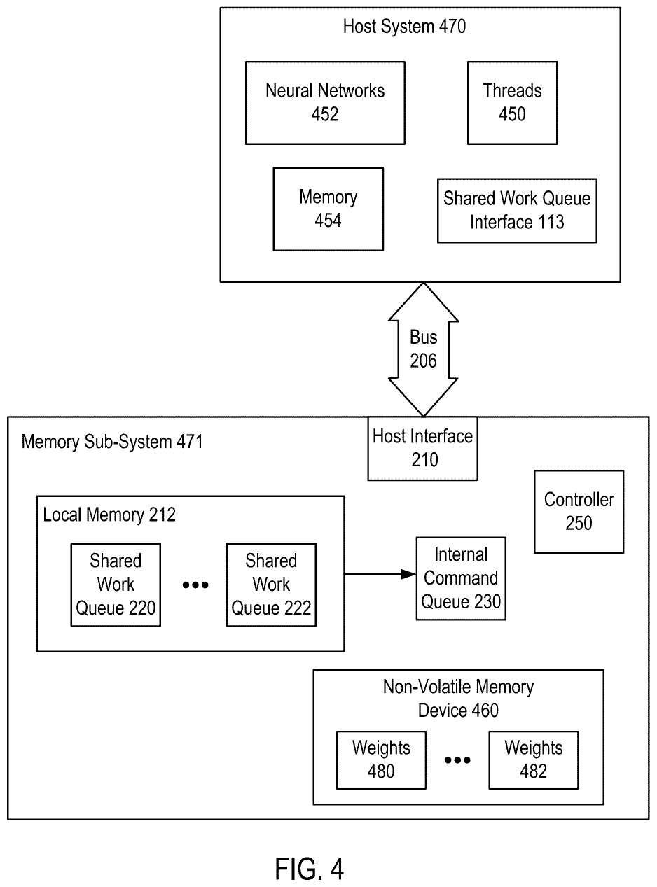

FIG. 4 shows a memory sub-system 471 having multiple shared work queues 220, 222. Threads 450 are executing in a host system 470 according to one embodiment. In general, any thread 450 can use any SWQ that is exposed by memory sub-system 471. In one example, the SWQ is selected for use based on a policy. In one example, a thread may use a first SWQ for a first command, and a different SWQ for a next command.

Host system 470 is an example of host system 102. Memory sub-system 471 is an example of memory sub-system 101. Memory 454 is an example of memory 106, 204, 304.

Host system 470 includes one or more cores (not shown). Each core executes one or more threads 450. Threads 450 are executed, for example, during training of one or more neural networks 452.

During the training of neural networks 452, various weights 480, 482 used in the training can be stored in non-volatile memory device 460 in response to commands sent by one or more threads 450 to one of the shared work queues 220, 222. Weights 480, 482 can also be read from non-volatile memory device 460 in response to commands sent by one or more threads 450 to one of the shared work queues 220, 222. The received commands are sent to internal command queue 230 for processing to access non-volatile memory device 460.

Weights 480, 482 can be written by controller 250 to memory 454 (e.g., using direct memory access (DMA)) when read from non-volatile memory device 460. Weights for 480, 484 can be read by controller 250 from memory 454 when written to non-volatile memory device 460.

Shared work queue interface 113 can manage commands issued by various threads 450. For example, shared work queue interface 113 can order and/or organize the commands for sending to shared work queue 220 as transaction layer packets (e.g., TLPs 307) over bus 206. For example, shared work queue interface 113 can associate the commands with addresses of the shared work queues 220, 222.

In one embodiment, each thread 450 uses one of the shared work queues 220, 222. In one embodiment, shared work queue interface 113 selects an SWQ used by a thread. In one embodiment, host system 470 selects an SWQ used by a thread 450.

In one example, many threads 450 execute in parallel during training of a neural network 452. Work requests of the threads are sent in parallel to shared work queues 220, 222.

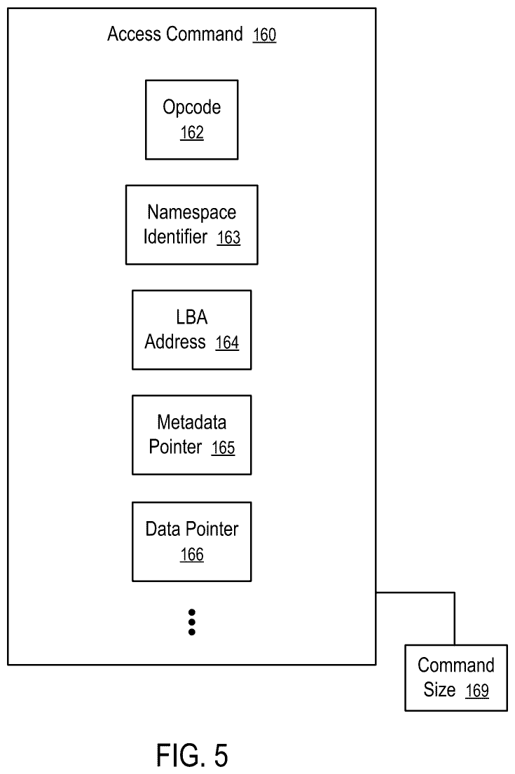

FIG. 5 shows an access command configuration according to one embodiment. For example, an access request can be implemented according to the access command 160 of FIG. 5. Access command 160 is an example of a command sent from host system 202 to shared work queue 220. Access command 160 is an example of a command sent to one of slots 360, 362.

In FIG. 5, the access command 160 can have a predetermined command size 169 (e.g., 64 bytes according to a version of NVMe standard). The access command 160 can have a plurality of predefined fields, such as opcode 162, namespace identifier 163, LBA address 164, metadata pointer 165, data pointer 166, etc.

For example, the predefined fields can be in compliance with a version of NVMe standard (e.g., base specification version 2.0). The opcode 162 can be configured to specify whether the command 160 is to be executed to read data or to write data (or another operation). The namespace identifier 163 can be configured to specify a namespace for the interpretation of the LBA address 164. The LBA address 164 identifies, in the namespace, a logical block having the predefined logical block size (e.g., 512 bytes, or larger). The metadata pointer 165 can be configured to provide an address of a physical buffer of metadata. The data pointer 166 can be configured to provide an entry used for data transfer, such as an entry to facilitate data transfer via physical region page (PRP).

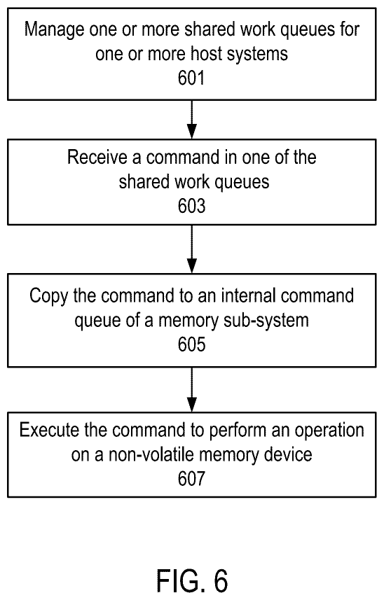

FIG. 6 shows a method for sending commands to a shared work queue of a memory sub-system according to one embodiment. The method of FIG. 6 can be performed by processing logic that can include hardware (e.g., processing device, circuitry, dedicated logic, programmable logic, microcode, hardware of a device, integrated circuit, etc.), software/firmware (e.g., instructions run or executed on a processing device), or a combination thereof. In some embodiments, the method of FIG. 6 is performed at least in part by the processing device 118 of the host system 102, the controller 115 of the memory sub-system 101, and/or the local media controller 105 of the memory sub-system 101 in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

For example, the method of FIG. 6 can be implemented using the shared work queue interfaces 113 of FIG. 1 to perform the operations illustrated in FIGS. 2-4.

At block 601 in FIG. 6, one or more shared work queues are managed to provide access for one or more host systems. In one example, controller 250 provides access to host system 202 for sending commands to shared work queues 220, 222.

At block 603, a command is received in one of the shared work queues. In one example, a command 380 is sent to shared work queue 320 using a transaction layer packet 307.

As mentioned above, a PCIe memory write can be used to write a command to shared work queue 222. In one example, a memory write (MWr) is used. This is a posted write and no PCIe completion TLP is returned to the sender of the data to write. In one example, a deferred memory write (DMWr) is used. This is a write with a completion TLP returned to the sender.

In some embodiments, the command can be a UIO write. For example, the PCIe 6.1 specification describes a type of PCIe memory write referred to as a “UIO write”. The UIO write behaves similarly as a deferred memory write and has a TLP completion. The completion can indicate if a retry is needed. In one example, a UIO write can be used in place of (substituted for) a deferred memory write as described herein with the same effect.

At block 605, the command is copied to an internal command queue of a memory sub-system. In one example, thread 450 sends a work request to shared work queue 222. The work request includes a command to write weight 482 to a logical storage space of memory sub-system 471 identified by an LBA address. After receiving the work request, controller 250 copies the command to internal command queue 230.

At block 607, the command is executed to perform an operation on a non-volatile memory device. In one example, the command is executed to store weight 482 in non-volatile memory device 460.

In some aspects, the techniques described herein relate to a memory sub-system (e.g., 208, 308, 471) including: at least one non-volatile memory device (e.g., 240); and at least one controller (e.g., 250) configured to: provide access to at least one shared work queue (e.g., 220) by exposing a portion of memory to a host system; receive, in the shared work queue, a command from the host system; and in response to receiving the command, copy the command to an internal command queue (e.g., 230) for execution to access the non-volatile memory device according to an operation identified in the command.

In some aspects, the techniques described herein relate to a memory sub-system, wherein the identified operation is a read or write operation.

In some aspects, the techniques described herein relate to a memory sub-system, wherein the exposed portion of memory is in a local memory (e.g., 212) of the controller.

In some aspects, the techniques described herein relate to a memory sub-system, wherein access to the shared work queue is provided by exposing a range of addresses to the host system.

In some aspects, the techniques described herein relate to a memory sub-system, wherein the range of addresses is exposed via a base address register (BAR).

In some aspects, the techniques described herein relate to a memory sub-system, further including a host interface (e.g., 210) configured to operate on a computer bus (e.g., 206), wherein: the command is configured to identify a logical block; and the controller is further configured to transfer, over the computer bus according to an opcode provided in the command, data for the logical block.

In some aspects, the techniques described herein relate to a memory sub-system, wherein the command specifies a memory address to access a memory (e.g., 204) of the host system to transfer the data for the logical block.

In some aspects, the techniques described herein relate to a memory sub-system, wherein the logical block is identified using a logical block addressing (LBA) address.

In some aspects, the techniques described herein relate to a memory sub-system, wherein the command is configured according to a standard for communications between memory sub-systems and host systems.

In some aspects, the techniques described herein relate to a memory sub-system, wherein the standard is a standard for non-volatile memory express (NVMe).

In some aspects, the techniques described herein relate to a memory sub-system including: non-volatile memory cells (e.g., 340); and at least one controller (e.g., 350) configured to: receive, in a shared work queue (e.g., 320), work requests from a host system, wherein the shared work queue has multiple slots (e.g., 360, 362) each of a fixed size, each slot receives a work request, and each work request includes an access command; and in response to receiving each work request, execute the corresponding access command to perform an operation on the non-volatile memory cells.

In some aspects, the techniques described herein relate to a memory sub-system, wherein each work request is delivered to a host interface of the memory sub-system using a transaction layer packet (TLP).

In some aspects, the techniques described herein relate to a memory sub-system, wherein: a first TLP is targeted to the shared work queue; the first TLP contains a data payload including at least one first access command; and the controller is further configured to, in response to receiving the first TLP, immediately copy the data payload into an internal queue of the memory sub-system from which the first access command will be processed.

In some aspects, the techniques described herein relate to a memory sub-system, wherein a root complex of a connection fabric emits each TLP aligned on a boundary having a fixed size in bytes, and each TLP has a data payload that is equal to or a multiple of the fixed size.

In some aspects, the techniques described herein relate to a memory sub-system, wherein multiple work requests are delivered to the memory sub-system using a single transaction layer packet (TLP).

In some aspects, the techniques described herein relate to a memory sub-system, wherein the transaction layer packet is configured according to a standard for peripheral component interconnect express (PCIe).

In some aspects, the techniques described herein relate to a memory sub-system, wherein the operation is retrieving data from the memory cells or storing data in the memory cells.

In some aspects, the techniques described herein relate to a memory sub-system, wherein the host system invokes a store instruction to queue each work request.

In some aspects, the techniques described herein relate to a memory sub-system, further including a command queue (e.g., 330) to order access commands for execution by the controller, wherein the controller is further configured to, when receiving a transaction layer packet (TLP) targeted to the shared work queue, store one or more access commands of the TLP in the command queue without any dependency on other TLPs.

In some aspects, the techniques described herein relate to a memory sub-system including: at least one non-volatile memory device (e.g., 460); and at least one controller (e.g., 250) configured to: receive, in a first queue of a plurality of shared work queues (e.g., 220, 222), a first command from a host system, wherein a plurality of threads (e.g., 450) execute on the host system for training a neural network (e.g., 452), and each thread uses one of the shared work queues; and in response to receiving the first command, perform an operation on the non-volatile memory device, wherein the operation is specified by the first command.

In some aspects, the techniques described herein relate to a memory sub-system, wherein the host system is configured to select an SWQ for use by each thread.

In some aspects, the techniques described herein relate to a memory sub-system, wherein the threads execute in parallel.

In some aspects, the techniques described herein relate to a memory sub-system, wherein work requests of the threads are sent in parallel to the memory sub-system.

In some aspects, the techniques described herein relate to a memory sub-system, wherein the work requests are associated with the training of the neural network, and weights (e.g., 480, 482) generated during the training are stored in or retrieved from the non-volatile memory device.

In some aspects, the techniques described herein relate to a memory sub-system, wherein the first command has a plurality of predefined fields including an opcode, a namespace identifier, and an LBA address.

In some aspects, the techniques described herein relate to a memory sub-system, wherein the predefined fields are in compliance with a standard for non-volatile memory express (NVMe).

In some aspects, the techniques described herein relate to a memory sub-system, wherein the opcode is configured to specify whether the first command is to be executed to read data or to write data.

In some aspects, the techniques described herein relate to a memory sub-system, wherein the namespace identifier is configured to specify a namespace for interpretation of the LBA address.

In some aspects, the techniques described herein relate to a memory sub-system, wherein the LBA address identifies, in the namespace, a logical block having a predefined logical block size.

In some aspects, the techniques described herein relate to a method including: providing, by a memory sub-system, access to at least one shared work queue by exposing a portion of memory to a host system; receiving, by the memory sub-system from the host system, a command in the shared work queue; and in response to receiving the command, copying, by the memory sub-system, the command to an internal command queue for execution to access a non-volatile memory device according to an operation identified in the command.

In some aspects, the techniques described herein relate to a non-transitory computer storage medium storing instructions which, when executed in a memory sub-system, cause the memory sub-system to perform a method, including: providing, by the memory sub-system, access to at least one shared work queue by exposing a portion of memory to a host system; receiving, by the memory sub-system from the host system, a command in the shared work queue; and in response to receiving the command, copying, by the memory sub-system, the command to an internal command queue for execution to access a non-volatile memory device according to an operation identified in the command.

A non-transitory computer storage medium can be used to store instructions programmed to implement the shared work queue 113 in the host system 102 and the memory sub-system 101. When the instructions are executed by the processing device 118, the controller 115, and the processing device 117, the instructions cause the host system 102 and/or the memory sub-system 101 to perform the methods discussed above.

Various embodiments related to memory systems using a shared work queue to receive commands configured with an address for a completion record are now described below. The generality of the following description is not limited by the various embodiments described above.

For purposes of illustration, some exemplary embodiments are described below in the context of an NVMe solid-state drive. However, the methods and systems of the present disclosure are not limited to use in an NVMe SSD.

To eliminate the need for use of a completion queue, various embodiments are now described in which commands transmitted via a shared work queue (SWQ) are configured with a field to specify the address for the completion record of a given command. When a host system (e.g., SSD) completes execution of a command transmitted via the SWQ, the host system generates a completion record and writes the record to the address specified in the command. This approach eliminates the need to use a completion queue as in the legacy use case, and also simplifies matching of the completion record with the corresponding command.

In one embodiment, an NVMe SSD includes NAND flash memory. A controller of the SSD receives, in a shared work queue, commands from a host system (e.g., GPU). Each command specifies an address for a completion record. In response to receiving the command, the controller executes the command to perform an operation (e.g., read or write) identified in the command. Then, the controller writes (or otherwise sends) the completion record to a location in main memory of the host system at the address.

In one embodiment, a host system sends commands to a shared work queue of a memory sub-system (e.g., SSD). Each command specifies an address in memory of the host system for writing a completion record. The host system receives the completion record from the memory sub-system after execution of the command by the memory sub-system. The host system stores the received completion record at the address. The host system evaluates data (e.g., a phase bit) in a predefined field of the received completion record to determine whether the command has been executed.

In one embodiment, a controller of an SSD receives, in an SWQ, commands from a host system. The SWQ has multiple slots each of a fixed size, each slot receives a command, and each command specifies a respective address for a completion record. In response to receiving each command, the controller moves the command to an internal command queue to execute the command to perform an operation on non-volatile memory cells. When completed, the controller sends (e.g., writes) the completion record for the command to the respective address. Each command is delivered to the SSD using a transaction layer packet (TLP) configured according to a standard for peripheral component interconnect express (PCIe).

In one embodiment, a solid-state drive fetches an NVMe command from an internal command queue and processes the command. After completion of the command, the NVMe SSD writes the completion record at the address provided in the NVMe command. In one example, the SSD uses the double words DW2 and DW3 from the NVMe command to get the address of the completion record. The SSD takes DW2 and DW3 and clears the bit 0 of DW3 to get the completion address.

The SSD writes data to indicate the completion in the completion record. For example, the value of a phase bit in the completion record is set by the SSD to the complement of the bit 0 in DW3 of the NVMe command.

In one example, the SSD writes the completion records (e.g., each having a size of 8 B) to main memory of the host system. In one example, the SSD writes the completion records to one or more NVMe completion tables in memory of the host system.

The format of the completion record used for the SWQ interface is different, for example, from the format described in NVMe spec 2.0. The address of the NVMe completion record/entry and the current value of the phase bit in the completion record in the host/GPU memory is passed in the NVMe command to the SSD. A phase bit field of the command contains the value of the phase bit in the completion record at the time the NVMe command is sent.

In one embodiment, each completion record is stored at a completion address. After execution of a command, an SSD writes a completion record/entry/message to the completion address. A legacy use case completion queue is not necessary. A command sent from the host to the SSD includes a memory address to write a completion record specifically for that command. In one example, the SSD writes, over a PCIe bus, the data to the memory address.

In one embodiment, the completion record has an initial state when a command is sent, and a final state when a command is completed. In one embodiment, the initial state is indicated by a value of the phase bit (e.g., 0). The final state is indicated by a different value of the inverted phase bit (e.g., 1), which indicates to the host that the command is completed.

In one example, the address of the completion record and the initial state are passed to the SSD in the command. The SSD writes the completion record to a completion table or other memory of the host system after the command is executed.

In one embodiment, the completion record is a message from the SSD to the host system, specifying a number of items related to the execution of a command. In one example, these items/fields are specified in an NVMe standard. Some of the fields are command specific. Since the command specifies the memory address for writing the completion record, command fields as used in legacy use cases to identify the command from the completion record are not necessary.

In one embodiment, a phase bit is defined as a bit location in the memory at the memory address of the completion record. In one example, if the phase bit is 1 at the time of sending the command, the host system can check if it still has a value of 1 to determine whether the SSD has written the completion record to the memory address. Since the command sent from the host system tells the SSD that the phase bit is 1, the SSD needs to configure the completion record such that when the completion record is written to the memory address, the bit is inverted to become 0. When the host system sees 0 in the phase bit, the host system knows that the content in the memory at the address has the proper completion record written by the SSD. The same approach can be used for a phase bit starting with 0 and becoming 1 after the completion record is written.

After a completion record is written in the memory of the host, a controller of the host system can determine how to handle the completion record. For example, the host can determine whether and when to dispose of the record and/or free the memory location. In one example, the host can create a table to collect the completion records. In one example, the host can randomly allocate memory just-in-time to send the command in order to receive the completion record from the SSD for the command, or re-use the same allocated memory for another command. In one example, the host can keep the completion record as a prior record (or as don't-care content) to be overwritten by the SSD after the execution of another command.

In one example, the SSD clears the bit 0 of DW3 in the command that is received by the SWQ to obtain the completion address. Instead of using as part of an address, this bit 0 is used for storing the phase bit. This is possible because the completion records are 8 bytes aligned. Hence, the 3 lower bits of their address is always zero and can be used to store information.

This bit 0 is not part of the address for the SSD to write the completion record. The memory address can always have a zero in this bit location (or a one, for an odd configuration).

In one embodiment, a status field of the completion record is the same as specified in the NVMe standard (e.g., value of 0 on success).

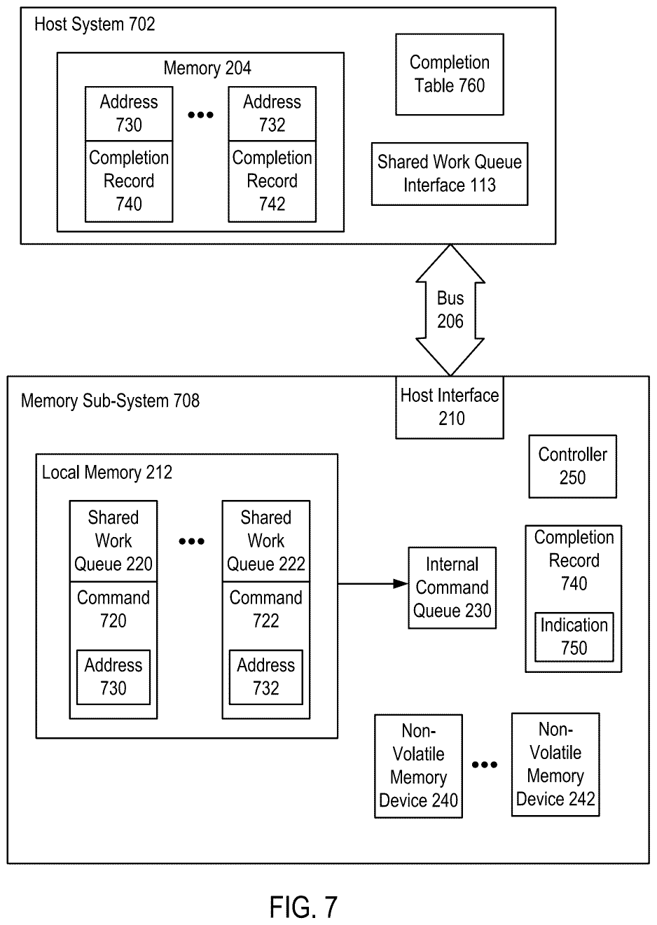

FIG. 7 shows a memory sub-system 708 having shared work queues 220, 222 to receive commands with an address for a completion record according to one embodiment. For example, commands 720, 722 are received from host system 702. Command 720 includes an address 730 that indicates a location in memory 204 of host system 702. Command 722 includes an address 732 that indicates a location in memory 204.

Host system 702 is similar to host system 202. Memory sub-system 708 is similar to memory sub-system 208. Addresses 730, 732 indicate locations at which controller 250 writes completion records after the respective commands 720, 722 are executed.

For example, commands 720, 722 are copied to internal command queue 230 for processing. After processing is completed, controller 250 generates completion records. For example, completion record 740 is generated after command 720 is processed. Completion record 740 includes an indication 750 that the command was executed. In one example, indication 750 is a value of a phase bit.

Controller 250 writes completion records to memory 204. For example, completion record 740 is written at address 730. Completion record 742 corresponds to completion of command 722 and is written at address 732. In one embodiment, completion records are written by controller 250 to completion table 760 (e.g., an NVMe completion table).

In one embodiment, the trigger for sending of the completion record by the controller 250 is a determination by controller 250 that execution of the command is completed. The completion record can include status information regarding execution (e.g., successful completion, or a type of error).

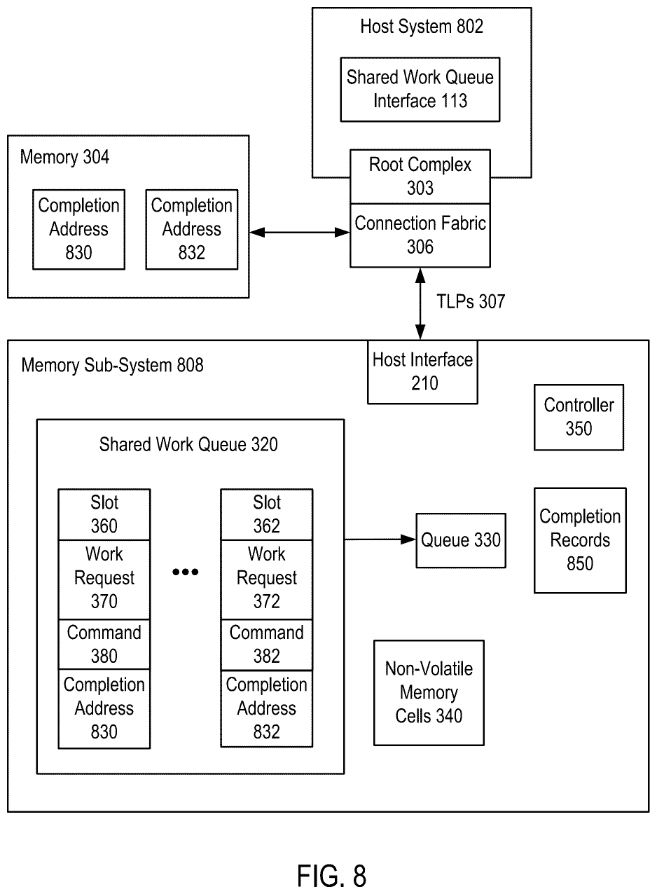

FIG. 8 shows a memory sub-system 808 having a shared work queue 320 that uses slots 360, 362 to receive commands 380, 382 each including a completion address 830, 832 according to one embodiment. Shared work queue 320 receives commands from a host system 802. Host system 802 is similar to host system 302. Memory sub-system 808 is similar to memory sub-system 308.

Each completion address 830, 832 points to a location in memory 304. When generating commands 380, 382 at host system 802, the host system 802 can allocate space in memory 304 for storing completion records corresponding to the commands. The allocation can be performed in response to a request by a process running on host system 802 (e.g., a process that sends command 830, 832).

In general, controller 350 copies commands from a shared work queue 320 to queue 330 for processing. Controller 350 generates completion records 850. Each completion record 850 is sent to memory 304 for storage at its respective completion address. In one example, each completion record 850 is sent by writing the record over connection fabric 306 to the corresponding completion address in memory 304.

In one embodiment, after completion records 850 are written to memory 304, host system 802 determines a final state of each completion record based on an indication in the record. In one example, the indication is a value of the phase bit. An initial state is defined by the value of the phase bit sent to shared work queue 320 in a corresponding command.

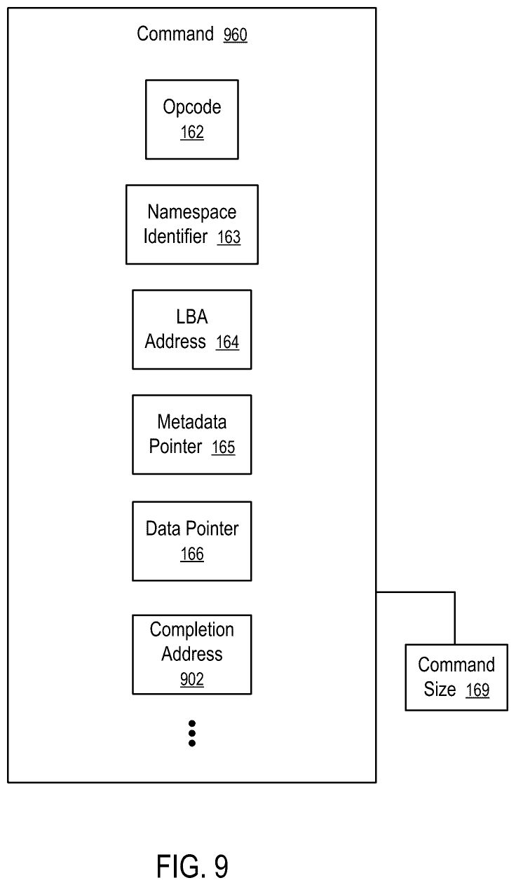

FIG. 9 shows a command configuration including a completion address according to one embodiment. Command 960 includes various predefined fields including a completion address 902. Command 960 is an example of command 720, 722, 380, 382. Completion address 902 is an example of completion addresses 830, 832. Command 960 is similar to access command 160.

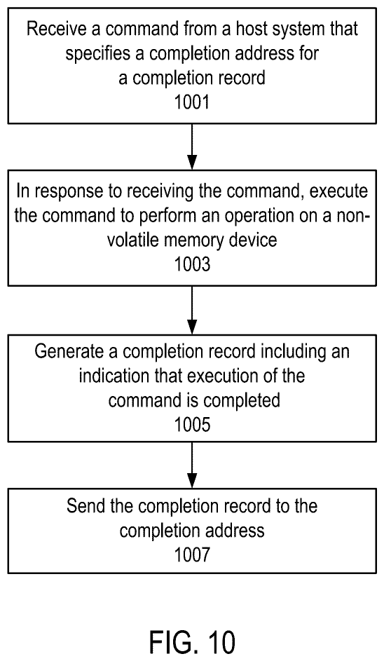

FIG. 10 shows a method for generating completion records for sending to a completion address specified by commands received in a shared work queue according to one embodiment. The method of FIG. 10 can be performed by processing logic that can include hardware (e.g., processing device, circuitry, dedicated logic, programmable logic, microcode, hardware of a device, integrated circuit, etc.), software/firmware (e.g., instructions run or executed on a processing device), or a combination thereof. In some embodiments, the method of FIG. 10 is performed at least in part by the processing device 118 of the host system 102, the controller 115 of the memory sub-system 101, and/or the local media controller 105 of the memory sub-system 101 in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

For example, the method of FIG. 10 can be implemented using the shared work queue interfaces 113 of FIG. 1 to perform the operations illustrated in FIGS. 7-8.

At block 1001 in FIG. 10, a command is received from a host system. The command is received by a shared work queue. The command specifies a completion address for a completion record that will be generated after the command is processed. In one example, the completion address is address 730, 732, 830, 832.

At block 1003, in response to receiving the command, the command is executed to perform an operation on a non-volatile memory device. In one example, the operation is a read or write operation on NAND flash memory cells. In one example, the command is copied to internal command queue 230 for execution.

At block 1005, a completion record is generated. The completion record includes an indication that execution of the command is completed. In one example, the indication is indication 750.

At block 1007, the generated completion record is sent to a location in memory at the completion address. In one example, completion record 740 is sent to memory 204.

In some aspects, the techniques described herein relate to a memory sub-system including: at least one non-volatile memory device; and at least one controller configured to: receive, in a shared work queue (e.g., 220, 222), a command (e.g., 720, 722) from a host system, wherein the command specifies an address (e.g., 730, 732) for a completion record; in response to receiving the command, execute the command to perform an operation identified in the command; and send the completion record (e.g., 740) to the address.

In some aspects, the techniques described herein relate to a memory sub-system, wherein the controller is further configured to provide access to the shared work queue by exposing a portion of memory to the host system.

In some aspects, the techniques described herein relate to a memory sub-system, wherein the controller is further configured to copy the command to an internal command queue for execution.

In some aspects, the techniques described herein relate to a memory sub-system, wherein the controller is further configured to access the non-volatile memory device according to the operation.

In some aspects, the techniques described herein relate to a memory sub-system, wherein the controller is further configured to send the completion record in response to determining that execution of the command is completed.

In some aspects, the techniques described herein relate to a memory sub-system, wherein the controller is further configured to generate the completion record, wherein the completion record includes an indication (e.g., 750) that execution of the command is completed.

In some aspects, the techniques described herein relate to a memory sub-system, wherein the command specifies the address for the completion record in a predefined field (e.g., 902) of the command.

In some aspects, the techniques described herein relate to a memory sub-system, wherein the address is a location in a memory of the host system.

In some aspects, the techniques described herein relate to a memory sub-system, wherein the memory is main memory of the host system.

In some aspects, the techniques described herein relate to a memory sub-system, wherein the address is for a location in a completion table (e.g., 760) managed by the host system.

In some aspects, the techniques described herein relate to a memory sub-system, wherein sending the completion record to the address includes writing the completion record to memory of the host system.

In some aspects, the techniques described herein relate to a host system (e.g., 702) including: memory; and at least one processing device configured to: send a command to a shared work queue of a memory sub-system, wherein the command specifies an address in the memory for a completion record (e.g., 742); receive the completion record from the memory sub-system after execution of the command; and store the received completion record at the address (e.g., 732).

In some aspects, the techniques described herein relate to a host system, wherein the processing device is further configured to evaluate data in a predefined field of the received completion record to determine whether the command has been executed.

In some aspects, the techniques described herein relate to a host system, wherein the command indicates an initial state, and the received completion record indicates a change in the initial state.

In some aspects, the techniques described herein relate to a host system, wherein the initial state is indicated by a first value of the command (e.g., an initial value of a phase bit), the change is indicated by a second value (e.g., a final value of a phase bit) of the received completion record, and the second value is different from the first value.

In some aspects, the techniques described herein relate to a host system, wherein the processing device is further configured to obtain the first value from an initial completion record, and the second value is used to update the initial completion record.

In some aspects, the techniques described herein relate to a host system, wherein the processing device is further configured to, when sending the command, allocate a portion of the memory for writing the completion record.

In some aspects, the techniques described herein relate to a host system, wherein the processing device is further configured to delete the completion record from the memory after determining that the command has been executed.

In some aspects, the techniques described herein relate to a host system, wherein the command is a prior command, the completion record is a prior completion record, and the processing device is further configured to: send a new command to the shared work queue, wherein the new command specifies the address for a new completion record; receive the new completion record from the memory sub-system after execution of the new command; and overwrite the prior completion record at the address using the new completion record.

In some aspects, the techniques described herein relate to a memory sub-system including: non-volatile memory cells; and at least one controller configured to: receive, in a queue, commands from a host system, wherein the queue has multiple slots (e.g., 360, 362), each slot receives a command, and each command specifies a respective address (e.g., 830, 832) for a completion record; and in response to receiving each command, execute the command to perform an operation on the non-volatile memory cells, and send the completion record (e.g., 850) for the command to the respective address.

In some aspects, the techniques described herein relate to a memory sub-system, wherein each command is delivered to a host interface of the memory sub-system using a transaction layer packet (TLP).

In some aspects, the techniques described herein relate to a memory sub-system, wherein the transaction layer packet is configured according to a standard for peripheral component interconnect express (PCIe).

In some aspects, the techniques described herein relate to a memory sub-system, wherein the queue is a shared work queue (e.g., 320).

In some aspects, the techniques described herein relate to a memory sub-system, wherein each slot has a fixed size.

Various embodiments related to memory systems using a shared work queue to receive commands including an address space identifier (e.g., PCIe PASID) are now described below. The generality of the following description is not limited by the various embodiments described above.

For purposes of illustration, some exemplary embodiments are described below in the context of an NVMe solid-state drive. However, the methods and systems of the present disclosure are not limited to use in an NVMe SSD.

Typically, numerous various processes (e.g., application programs in execution) are running on a host system. An operating system runs on the host system to manage the processes along with system resources, memory, and hardware devices (e.g., GPU). In one example, the processes include one virtual machine. In one example, the processes run in the same virtual machine. In one example, a process can be a bare metal container. For example, the host system can be a server or any other computing device having a central processing unit (CPU) on which the operating system runs.

Each process has its own dedicated address space. The operating system on which the process runs has a page table dedicated to the process. The page table translates virtual addresses from the process address space into physical addresses (e.g., locations in DRAM of main memory or PCIe device memory).

Multiple instances of a same program/application can run in the CPU/host, each having its own dedicated address space. The virtual addresses of the address space are translated into physical addresses using the page table. For example, these physical addresses are typically in the main memory of the host (e.g., the main DRAM of the computer or in a PCIe device memory).

Typically, each time a program is started, a process is created. When the program stops or ends, the process is removed. Each process has at least one thread. A thread is a unit of execution within the process. All the threads of the process share the same address space and same page table. For example, a running process has one or several of its threads executing on one or more CPUs of the host system.

The address space that is dedicated can be identified by an identifier assigned by the operating system (OS). In one example, the identifier is a Process Address Space ID (PASID) as defined in the PCIe specification. The Process Address Space ID, in conjunction with the Requester ID, uniquely identifies the address space associated with a memory transaction.

Each process that shares a PCIe device is assigned its own unique PASID by the OS. All the threads of a same process are associated to the same PASID, the one of their process.

In some cases, a process is referred to as a tenant when the process is one of many processes that share a device (e.g., an NVMe device). Examples of tenants include virtual machines (VMs) that use a same SSD. VMs are seen as processes by the host OS/hypervisor. Another example of tenants is processes running in a same VM/guest sharing an SSD assigned to the VM. In an example case with no VM, there can be several user space processes sharing a same SSD. In one example, these processes are bare metal containers.

Thus, according to the PCIe specification, a PASID is associated to one address space on the host side. And on the host side, for the OS, one address space corresponds to one process. So, there is a single PASID per process.

A technical problem can arise when a large number of tenants share a same device. For example, an SSD is shared by a large number of independent tenants (in a virtualization use case). These tenants need low latency access to the SSD. Hence, the tenants need direct access to a PCIe BAR address space of the SSD to be able to queue NVMe commands directly to the SSD. For example, the tenants could be processes running in a VM or bare metal containers.

Because these tenants are independent, the tenants cannot synchronize to share a same NVMe legacy queue pair (QP). Consequently, the tenants each would need a distinct QP. But the SSD resources needed to instantiate QPs are limited, and this prevents the number of tenants from scaling.

Tenants need to be isolated. If one tenant misbehaves (e.g., using wrong addresses in NVMe commands), the other tenants sharing the same NVMe SSD should not be impacted. When the number of tenants sharing an SSD increases significantly (e.g., beyond what SR-IOV can do), a PCIe PASID is used as described below to implement that isolation. The legacy NVMe interface does not provide a way for the host or GPU to pass PASIDs to the NVMe SSD. Thus, with the legacy NVMe interface, the number of such tenants cannot scale to large numbers.

To facilitate sharing of a device (e.g., an SSD) by a large number of independent tenants, various embodiments are now described in which commands transmitted via a shared work queue (SWQ) are configured to include an address space identifier (e.g., the Process Address Space ID (PASID)). For example, the field of Command ID for a command transmitted via a legacy submission queue is not useful for a command transmitted via SWQ. Thus, the field of Command ID (e.g., as described in NVMe specification 2.0) can be repurposed to hold 16 bits of the PASID. The rest of the PASID is placed in reserved bits of Dword 0 and lower bits of Dword 3.

In one embodiment, during execution of the command, the PASID can be used in a DMA data transfer. In one example, the PASID is used for memory access according to the PCIe standard with the virtualization feature. In one example, an SSD uses the PASID in compliance with PCIe standards in sending memory access/transaction requests.

In one example, the PASID enables sharing of a single endpoint device across multiple processes while providing each process a complete 64-bit virtual address space. This feature adds support for a TLP prefix that contains a 20-bit address space that can be added to memory transaction TLPs.

In one example, passing the PASID to the device via the SWQ is a building block of a Scalable I/O Virtualization (SIOV) solution.

In one example, tenants A and B share a same PCIe device. Each tenant is a process. Tenant A is assigned PASID A by the OS, and tenant B is assigned PASID B by the OS. For example, each tenant has 10 threads running and doing input/output operations (IOs). The 10 threads of tenant A when sending NVMe commands on the SWQ will insert PASID A in the NVMe commands. Tenant B threads will insert PASID B in the NVMe commands sent on the SWQ.

In one embodiment, received commands are moved to an internal command queue of an NVMe SSD. The SSD processes commands from the internal queue. Processing of each command is the same as in the legacy use case, except that TLPs initiated by the NVMe SSD (to process the command) use the PASID provided in the NVMe command (if the use of PASID by the SSD is enabled).

In one embodiment, an NVMe SSD includes flash memory. A controller of the SSD receives, in a shared work queue, commands from a host system. Each command is from a process executing on the host system. Each command includes an identifier for an address space (e.g., PASID) of the host system used by the process. In response to receiving the command, the SSD executes the command to access the flash memory according to an operation identified in the command. There are multiple tenants sharing the flash memory. The identifier is assigned to each process by an operating system executing on the host system.

In one embodiment, a host system sends commands to a shared work queue of a memory sub-system (e.g., SSD). The SSD receives, in one of multiple shared work queues, commands from processes. The processes are executing on a host system for training a neural network. The processes are running in one or more virtual machines. Each command includes an identifier for an address space of the process that sent the command.

The controller performs, based on the identifier, an operation on a non-volatile memory device of the SSD. The operation is specified by the respective command. In response to various received commands, the controller reads weights generated during the training from memory of the host system using a direct memory access (DMA) data transfer, and stores the weights in the non-volatile memory device.

In one embodiment, a system includes a direct memory access (DMA) engine, and a controller of an SSD. The SSD receives a command from a process. The command includes an address space identifier assigned to the process. The controller extracts the identifier from the command, and sends a DMA request to the DMA engine using the identifier.

In one embodiment, the command requests an operation, and the controller notifies the process when the requested operation is completed. In one example, the controller notifies the process by sending a completion record to an address identified in the command.

Various advantages are provided by use of the PASID for at least some embodiments herein. For example, use of the SWQ interface and address space identifier allows scalability for a large number of independent tenants sharing a same NVMe SSD.

For example, by passing the PASID in the NVMe command, even using only one SWQ: any number of tenants (up to the PASID capacity) can be accommodated; no new resource needs to be allocated on the NVMe SSD when new tenants appear; and no resource re-allocation on the NVMe SSD is required when tenants disappear. On the NVMe SSD itself, there is no need to partition the interface resource across tenants (e.g., such as would be the case with the legacy interface where a NVMe QP would be assigned to a PASID).

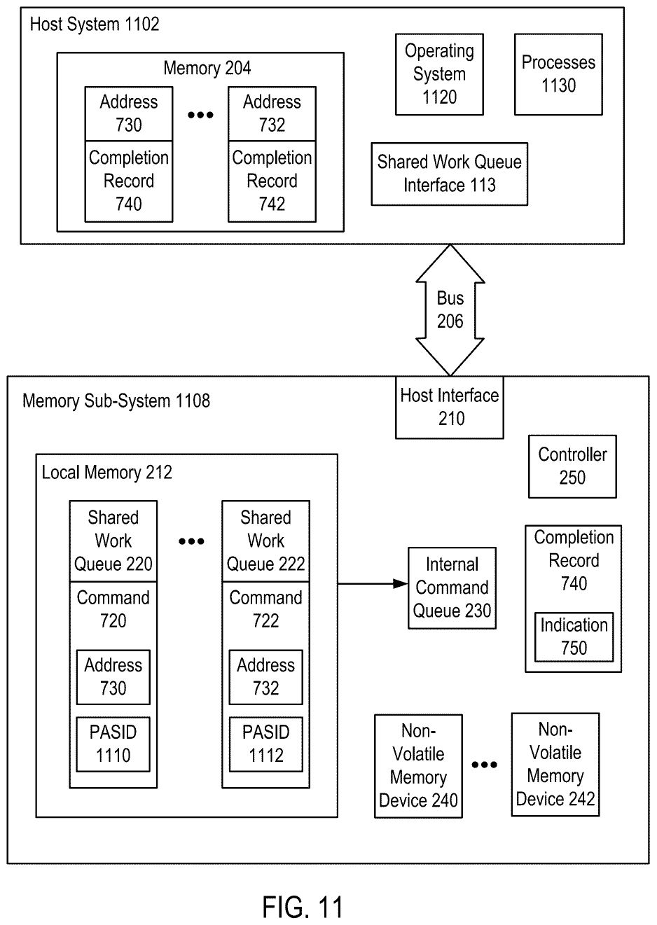

FIG. 11 shows a memory sub-system 1108 having multiple shared work queues 220, 222 to receive commands 720, 722 including an address space identifier 1110, 1112 according to one embodiment. In one example, the address space identifier is a PASID.

Commands 720, 722 are received from processes 1130 running on operating system 1120 of host system 1102. Each command includes an address space identifier that identifies address space of the processes that sent the command. Each process 1130 is assigned an address space identifier by operating system 1120 when created.

Each command 720, 722 is copied to internal command queue 230 for execution. When each command is executed, the address space identifier 1110, 1112 of the particular command is used for performing data transfer associated with an operation specified by the command. In one example, the address space identifier is passed to a DMA engine for use in configuring and/or performing the data transfer.

Host system 1102 is similar to host system 702. Memory sub-system 1108 is similar to memory sub-system 708.

In one example, each process 1130 runs in a virtual machine. In one example, one or more of processes 1130 is a virtual machine executing on a hypervisor of host system 1102.

In one embodiment, controller 250 manages at least one characteristic of data transfer based on the address space identifier. In one example, the identifier is used for performing memory translations (e.g., to identify a page table).

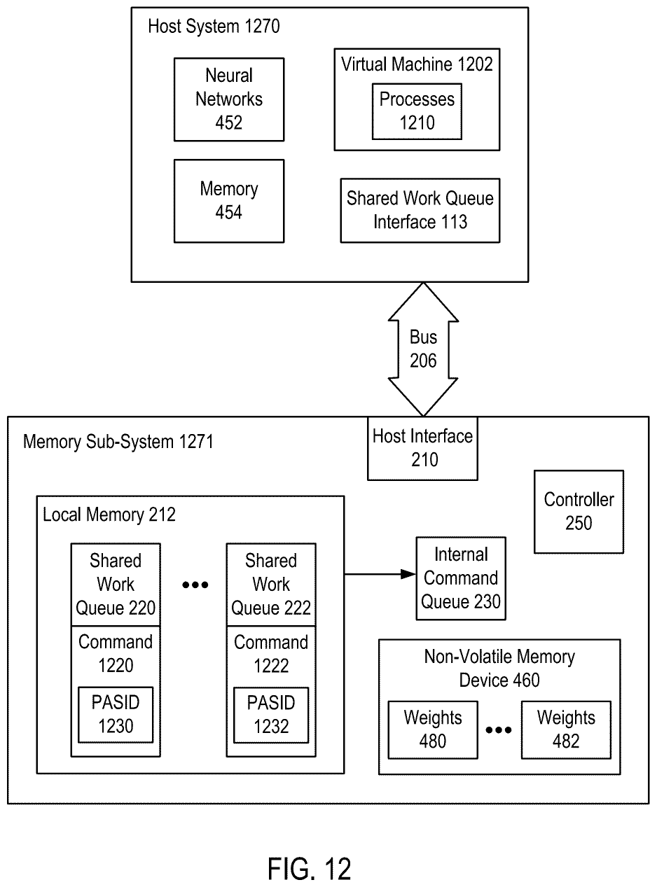

FIG. 12 shows a memory sub-system 1271 having multiple shared work queues 220, 222 to receive commands 1220, 1222 from processes 1210 executing on a host system 1270 to train one or more neural networks 452 according to one embodiment. Host system 1270 is similar to host system 470. Memory sub-system 1271 is similar to memory sub-system 471. Processes 1210 are an example of processes 1130.

Each command 1220, 1222 includes an address space identifier 1230, 1232. In one example, the identifier is a PASID. In one example, identifier 1230, 1232 is used similarly as described above for identifier 1110, 1112.

Processes 1210 run in a virtual machine 1202 on host system 1270. Processes 1210 are used to train neural networks 452. Weights 480, 482 are stored in non-volatile memory device 460 during this training in response to commands 1220, 1222. Data associated with training neural networks 452 can also be stored in main memory 454 in an address space(s) of one or more processes 1210. In one example, the address space(s) is identified by identifier 1230, 1232.

Controller 250 uses address space identifier 1230, 1232 to configure data transfer for an operation specified in the respective command. In one example, controller 250 passes the identifier to a DMA engine for handling this configuration.

In one embodiment, controller 250 determines a priority of an operation specified by a command based on the address space identifier in the command. In one example, a higher priority operation of a later-received command can be executed prior to a lower priority operation of an earlier-received command.

In one embodiment, a process 1210 includes multiple threads. Each thread generates work requests that are sent in parallel to one of shared work queues 220. Each thread invokes a store instruction to queue a respective one of the work requests.

In one embodiment, a thread of process 1210 running on a processor (e.g., a CPU on host system 1270) invokes a specific store instruction to queue a work request. The processor implements the store instruction. The store instruction has the following input parameters: SWQ address, and a pointer to the work request or NVMe command. In one embodiment, the store instruction itself places the PASID in the work request. In one example, the SWQ address is an address of shared work queue 220. In one example, the valid PASID is PASID 1230.

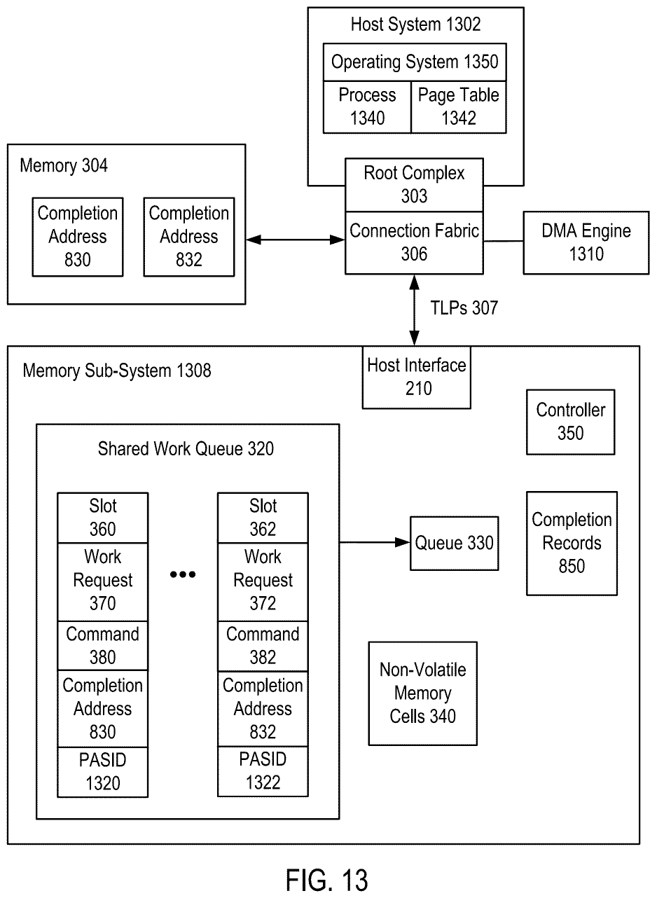

FIG. 13 shows a memory sub-system 1308 having a shared work queue 320 to receive commands 380, 382 each including an address space identifier 1320, 1322 used by a direct memory access (DMA) engine 1310 to perform data transfer corresponding to the commands according to one embodiment. In one example, each command is received as part of a work request 370, 372. In one example, each work request is received by one of slots 360, 362. In one example, the address space identifier is the PASID of the process that sends the command and/or generates the work request.

DMA engine 1310 can be located in memory sub-system 3008, host system 1302, or on a separate device. Memory sub-system 1308 is similar to memory sub-system 808. Host system 1302 is similar to host system 802.

DMA engine 1310 receives the address space identifier from controller 350 when the corresponding command is executed or handled. The DMA engine 1310 uses the address space identifier in performing a data transfer.

Operating system 1350 runs on host system 1302. Process 1340 is assigned an address space identifier by operating system 1350. Page table 1342 is used for address mapping translations associated with the address space of process 1340. In the case that the DMA engine 1310 uses untranslated addresses (it places the PASID and untranslated address in the TLP), the host TA (translation agent) when receiving the TLP from the Root Complex, will translate the address using the PASID and page table 1342. In the case that the DMA engine 1310 uses translated addresses (it places translated address and no PASID in the TLP), it needs first to obtain a translation from the host ATS (Address Translation Service). DMA engine 1310 does that by sending a translation request to the host ATS providing the PASID and untranslated address. The host ATS uses the PASID and page table 1342 to translate in performing data transfers when executing operations specified by commands 380, 382.

In one embodiment, process 1340 requests an operation specified by command 380. Controller 350 notifies process 1340 when the requested operation is completed. In one example, controller 350 notifies process 1340 and/or host system 1302 that a requested operation is completed by sending a completion record to an address identified in the command 380. In one example, the address is completion address 830.

In one example, DMA engine 1310 accesses host memory 304 such that a host/CPU of host system 1302 does not have to be involved in transferring data to/from host memory 304 (e.g., RAM). For example, a DMA engine of an SSD can be used to access the data in the host memory/RAM, such as fetching data to be written into the SSD for execution of a write command (e.g., 380), and saving data retrieved during execution of a read command (e.g., 382). The host does not actively read/write the data from the SSD. Instead, the host sends the NVMe commands to tell the SSD where to fetch the data for a write command (e.g., using data pointer 166), and where to save the data for a read command (e.g., using data pointer 166).

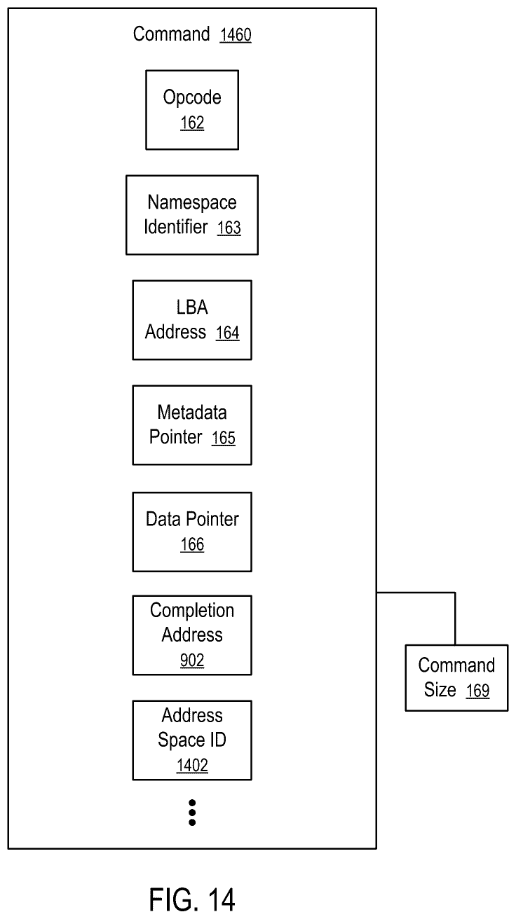

FIG. 14 shows a command configuration including an address space identifier according to one embodiment. Command 1460 includes various predefined fields including address space identifier 1402. Command 1460 is an example of command 1220, 1222, 720, 722, 380, 382. Command 1460 is similar to access command 160, 960.

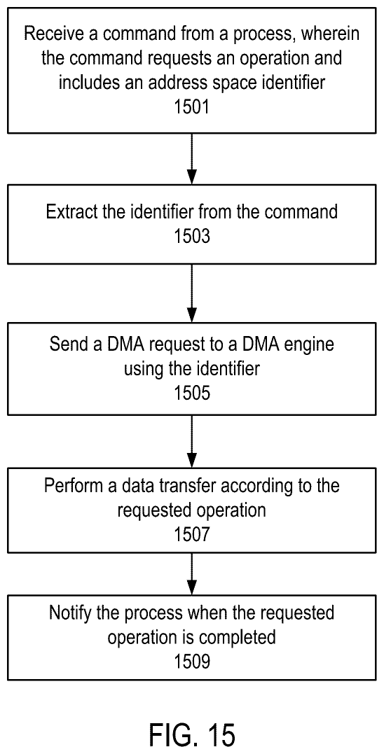

FIG. 15 shows a method for performing direct memory access (DMA) data transfers using address space identifiers specified by commands received in a shared work queue according to one embodiment. The method of FIG. 15 can be performed by processing logic that can include hardware (e.g., processing device, circuitry, dedicated logic, programmable logic, microcode, hardware of a device, integrated circuit, etc.), software/firmware (e.g., instructions run or executed on a processing device), or a combination thereof. In some embodiments, the method of FIG. 15 is performed at least in part by the processing device 118 of the host system 102, the controller 115 of the memory sub-system 101, and/or the local media controller 105 of the memory sub-system 101 in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

For example, the method of FIG. 15 can be implemented using the shared work queue interfaces 113 of FIG. 1 to perform the operations illustrated in FIGS. 11-13.

At block 1501 in FIG. 15, a command is received from a process. The command requests an operation and includes an address space identifier assigned to the process. In one example, command 380 is received from process 1340.

At block 1503, the address space identifier is extracted from the command. In one example, controller 350 extracts address space identifier 1320 from command 380.

At block 1505, the address space identifier is used to send a DMA request to a DMA engine. In one example, controller 350 sends the extracted address space identifier 1320 to DMA engine 1310.

At block 1507, a data transfer is performed according to the requested operation. In one example, DMA engine 1310 uses connection fabric 306 to read data from memory 304 and write the data to non-volatile memory cells 340.

At block 1509, the process is notified when the requested operation is completed. In one example, controller 350 sends a completion record 850 to completion address 830.

In some aspects, the techniques described herein relate to a memory sub-system (e.g., 1108) including: at least one non-volatile memory device; and at least one controller (e.g., 250) configured to: receive, in a shared work queue (e.g., 220), a command (e.g., 720) from a process (e.g., 1130) executing on a host system (e.g., 1102), wherein the command includes an identifier (e.g., 1110) for an address space of the host system used by the process; and in response to receiving the command, execute the command to access the non-volatile memory device according to an operation identified in the command.

In some aspects, the techniques described herein relate to a memory sub-system, wherein the process is one of multiple tenants sharing the memory sub-system.

In some aspects, the techniques described herein relate to a memory sub-system, wherein the identifier is assigned to the process by an operating system executing on the host system.

In some aspects, the techniques described herein relate to a memory sub-system, wherein the identifier is a process address space ID (PASID) according to a standard for peripheral component interconnect express (PCIe).

In some aspects, the techniques described herein relate to a memory sub-system, wherein the operation is a write operation and the command identifies a logical block of the non-volatile memory device (e.g., 240), and the identifier is used for performing data transfer from a location in memory (e.g., 204) of the host system to the logical block.

In some aspects, the techniques described herein relate to a memory sub-system, wherein the operation is a read operation and the command identifies a logical block of the non-volatile memory device, and the identifier is used for performing data transfer from the logical block to a location in memory of the host system.

In some aspects, the techniques described herein relate to a memory sub-system, wherein the command is delivered to a host interface of the memory sub-system using a transaction layer packet (TLP).

In some aspects, the techniques described herein relate to a memory sub-system, wherein executing the command includes retrieving data from the non-volatile memory device, and the controller is further configured to write the data in main memory of the host system using a direct memory access (DMA) data transfer.

In some aspects, the techniques described herein relate to a memory sub-system, wherein performance of the DMA data transfer is configured by the controller based on the identifier.

In some aspects, the techniques described herein relate to a memory sub-system, wherein the controller manages at least one of bandwidth or latency.

In some aspects, the techniques described herein relate to a memory sub-system, wherein memory translations are performed based on the identifier.

In some aspects, the techniques described herein relate to a memory sub-system, wherein storage resources are assigned to at least one virtual machine based on the identifier.

In some aspects, the techniques described herein relate to a memory sub-system (e.g., 1271) including: at least one non-volatile memory device; and at least one controller configured to: receive, in a first queue (e.g., 220) of a plurality of shared work queues, a first command (e.g., 1220) from a first process, wherein the first process is one of a plurality of processes executing on a host system for training a neural network (e.g., 452), and the first command includes an identifier (e.g., 1230) for an address space of the first process; and perform, based on the identifier, an operation on the non-volatile memory device, wherein the operation is specified by the first command.

In some aspects, the techniques described herein relate to a memory sub-system, wherein a priority of the operation is determined by the controller based on the identifier.

In some aspects, the techniques described herein relate to a memory sub-system, wherein the processes are running in a virtual machine (e.g., 1202) on the host system.

In some aspects, the techniques described herein relate to a memory sub-system, wherein the controller is further configured to read weights (e.g., 480, 482) generated during the training from memory of the host system using a direct memory access (DMA) data transfer, and store the weights in the non-volatile memory device.

In some aspects, the techniques described herein relate to a memory sub-system, wherein the first command has a plurality of predefined fields including a first field (e.g., 1402) having the identifier.

In some aspects, the techniques described herein relate to a memory sub-system, wherein the first field is defined by a standard for non-volatile memory express (NVMe) for specifying a command ID of the first command, and the first field specifies the identifier instead of the command ID.

In some aspects, the techniques described herein relate to a memory sub-system, wherein the first process includes multiple threads, and work requests of the threads are sent in parallel to the memory sub-system.

In some aspects, the techniques described herein relate to a memory sub-system, wherein each thread invokes a store instruction to queue a respective one of the work requests.

In some aspects, the techniques described herein relate to a memory sub-system, wherein the store instruction has input parameters including an address of one of the shared work queues, and a pointer to the respective one of the work requests.

In some aspects, the techniques described herein relate to a system including: a direct memory access (DMA) engine (e.g., 1310); and at least one controller (e.g., 350) configured to: receive a command (e.g., 380) from a process (e.g., 1340), wherein the command includes an address space identifier (e.g., 1320) assigned to the process; extract the identifier from the command; and send a DMA request to the DMA engine using the identifier.

In some aspects, the techniques described herein relate to a system, wherein the command includes a virtual address for memory of a host system, and the DMA engine is configured to determine a physical address in the memory based on the virtual address and the identifier.

In some aspects, the techniques described herein relate to a system, wherein the DMA engine determines the physical address using a page table (e.g., 1342) dedicated to the process by an operating system (e.g., 1350) running on the host system.

In some aspects, the techniques described herein relate to a system, wherein the command requests an operation, and the controller is configured to notify the process when the requested operation is completed.

In some aspects, the techniques described herein relate to a system, wherein the controller is further configured to notify the process by sending a completion record to an address (e.g., completion address 830) identified in the command.

In some aspects, the techniques described herein relate to a system, wherein the DMA engine is configured to select a mode for data transfer.

Various embodiments related to formats for commands and completion records used in memory systems having a shared work queue are now described below. The generality of the following description is not limited by the various embodiments described above.

For purposes of illustration, some exemplary embodiments are described below in the context of an NVMe solid-state drive. However, the methods and systems of the present disclosure are not limited to use in an NVMe SSD.

In many cases, it is desirable that a memory system be compatible with existing protocols or standards. This can enhance ease-of-use and compatibility with existing equipment. If functionality is added or changes made to a memory system in a way that causes one or more incompatibilities with existing protocols or standards, a technical problem may arise in which the memory system does not function properly with existing devices and/or for desired use.

For improved compatibility with existing standards (e.g., NVMe specification 2.0), the formats of SWQ-transmitted commands and their completion records can follow the formats of QP-transmitted commands and completion records.

Various embodiments are now described for which an SWQ-transmitted command can have substantially the same format as an NVMe command transmitted via a submission queue, except that the field of Command ID of the legacy use case can be replaced with a portion of the field of PASID, and the reserved fields in Dwords 2 and 3 in NVMe specification 2.0 are repurposed (e.g., for typical use cases, with some command specific exceptions described below) as the fields for the address of completion record and for the value of the phase bit in the completion record at the time the NVMe command is sent.

The submission queue head pointer, submission queue identifier and command identifier of the legacy use case are not needed in a completion record for an SWQ-transmitted command. Thus, these fields can be eliminated from a completion record for an SWQ-transmitted command. Further, bits 47-63 of the legacy reserved field can be eliminated to shorten the completion record to 8 bytes for use with an SWQ.

In one embodiment, an NVMe SSD includes a flash memory device and a controller. The controller receives, in a shared work queue of the SSD, a command from a process executing on a host system. The command is configured with predefined fields including an identifier for an address space of the host system used by the process (e.g., PASID), a completion address, and a phase bit. The predefined fields can include various other fields (e.g., legacy fields) such as a data pointer. For example, the data pointer is configured according to the non-volatile memory express (NVMe) standard.

In one embodiment, an NVMe SSD can be selectively configured to receive commands either via a legacy submission queue or in a shared work queue. For example, a controller can poll the submission queue and read any new entries in the submission queue. For example, the controller can receive commands in a shared work queue as described herein. For example, a host system can configure use by the SSD of either the submission queue or the shared work queue.

In one embodiment, the SSD receives, from a submission queue located in main memory of a host system, a first command configured with a predefined field, wherein the predefined field includes a command identifier. The predefined field is formatted according to the legacy use case NVMe standard.

The host system sends a signal to the SSD to change its configuration so that the SSD receives, in a shared work queue in local memory of the SSD, a second command from a process executing on the host system. The second command is configured with the predefined field, and the predefined field includes at least a portion of an identifier for an address space of the host system used by the process. Thus, the command identifier of the legacy command format is replaced by the portion of the address space identifier (e.g., PASID).

In one embodiment, an NVMe SSD sends completion records having a format that varies or depends on whether a corresponding executed command has been received via a submission queue or in a shared work queue. For example, a controller reads a submission queue to receive a first command configured with first and second reserved fields (e.g., Dwords 2 and 3) according to the legacy NVMe standard.

A host system changes the configuration of the SSD. As result, the controller receives, in a shared work queue, a second command from a process executing on the host system. The second command is configured with the first and second reserved fields, but the first and second reserved fields now include a completion address, a portion of an address space identifier, and a value of a phase bit. The first and second reserved fields are configured at a same format location in each of the first and second commands. The format location is defined by the NVMe standard.

Specifically, the first and second reserved fields are Dword2 and Dword3 of the command format according to the NVMe standard. The first reserved field contains a most significant bit of the completion address, and the phase bit is located at bit 0 of the second reserved field. The second reserved field also contains a portion of the address space identifier. The value for the phase bit is an initial value, and the completion record includes a final value for the phase bit that indicates whether execution of the second command is completed.

The controller sends a completion record to a completion queue for the legacy use case. The controller sends a completion record to the completion address for commands received in the shared work queue.

In one example, the format of a NVMe command in a work request is not the same as an NVMe command in the NVMe 2.0 specification. It is different in that 20 bits of the work request are used to store the PASID. Hence, only 60 B are available to place the other data for the NVMe command in the work request. Thus, data for a 64 B NVMe command (NVMe spec 2.0) needs to be fit into a smaller size of 60 B.

The Command ID is not relevant for use with an SWQ. With the legacy use case interface, the Command ID is used by the host or GPU to find the context of the NVMe command from the NVMe completion queue. In contrast, when using an SWQ, the host/GPU can determine the context from a completion record written to the completion address. The completion address for the NVMe completion entry and the current or initial value of the phase bit in the completion record in host/GPU memory is passed to the SSD in the NVMe command.

In one embodiment, regarding the format of an NVMe command used with the new interface, a phase bit field of the command contains the value of the phase bit in the completion record at the time the NVMe command is sent to the SSD. For example, the phase bit field is defined as bit 0 of Dword3 from the predefined format for an NVMe command used with the legacy interface.

In one embodiment, the format of a completion record for the new SWQ interface differs from the format of the completion record for the NVMe 2.0 specification. When using an SWQ, the submission queue head pointer, submission queue identifier and command identifier of the legacy use case are not needed. Consequently, the completion entry size is reduced from 16 B of the legacy use case to 8 B for the new SWQ interface. The completion record address (e.g., in host/GPU memory) is 8 bytes aligned.

In one embodiment, an NVMe SSD implementing the SWQ interface is fully backward compatible with the NVMe standard. For example, by default, the SSD is configured to behave the same as an NVMe SSD abiding by the NVMe 2.0 specification. Only after the SWQ interface is enabled in the SSD (e.g., using a set feature command sent by a host system to the SSD) does the NVMe SSD behave differently (e.g., provide SWQ interface functionality).

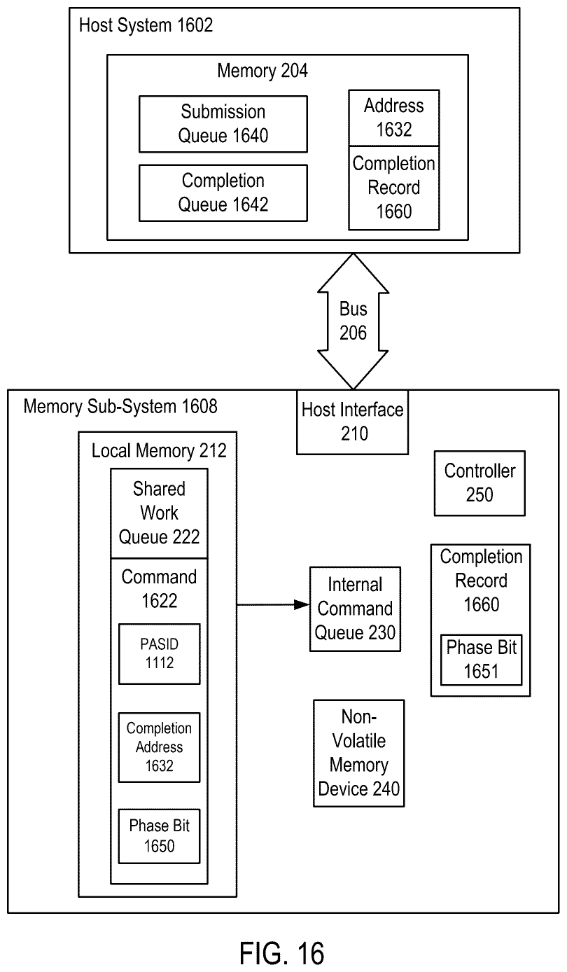

FIG. 16 shows a memory sub-system 1608 that can receive commands either from a submission queue 1640 of a host system 1602 or in a shared work queue 222 of the memory sub-system 1608 according to one embodiment. In one example, memory sub-system 1608 is similar to memory sub-system 1108, 1308. In one example, host system 1602 is similar to host system 1102, 1302.

Submission queue 1640 and completion queue 1642 are a queue pair (QP) according to the legacy use case. When configured for legacy use, controller 250 periodically checks to see if a command is present in submission queue 1640 (or a doorbell register is used). If so, controller 250 reads the command from submission queue 1640, executes the command, and generates a completion record (not shown) that is sent to completion queue 1642.

When configured for using a shared work queue interface (e.g., 113), controller receives commands from host system 1602 in shared work queue 222. For example, command 1622 is received and includes an address space identifier 1112, completion address 1632, and an initial value for phase bit 1650.

Command 1622 is moved to internal command queue 230. After execution, controller 250 generates completion record 1660. Completion record 1660 includes a final value for phase bit 1651. The final value indicates a status of the execution. Controller 250 sends the completion record 1660 to the completion address 1632 in memory 204. In one example, if use of a PASID has been enabled, then controller 250 uses the PASID when writing the completion record to the completion address.

In one example, completion record 1660 is in memory 204 (e.g., DRAM) of host system 1602. When command 1622 is sent by host system 1602, phase bit 1650 includes an initial value based on the last bit of the content located at address 1632. When controller 250 generates and writes completion record 1660 to memory 204, controller 250 inverts the initial value of phase bit 1650 to provide the final value of phase bit 1651. This permits host system 1602 to determine that the content in the completion record 1660 is new, updated, and/or valid. An advantage of using the phase bit is that the host system does not need to immediately process the completion record when controller 250 writes it to memory 204.

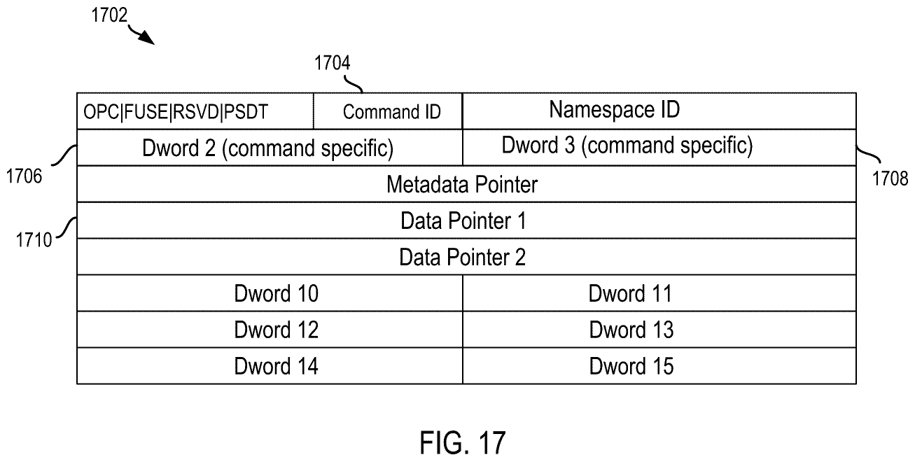

FIG. 17 shows a format 1702 of commands received via a submission queue of a legacy system. Format 1702 includes various predefined fields.

Format 1702 includes a field 1704 for a Command ID. Format 1702 includes reserved fields 1706, 1708. Although fields 1706, 1708 are typically reserved, there are certain NVMe commands that use Dwords 2 and 3. Format 1702 includes data pointer fields (e.g., 1710) along with other various fields.

In one example, the fields are defined by the NVMe 2.0 specification. The fields are located at double word (Dword) positions as defined by the specification.

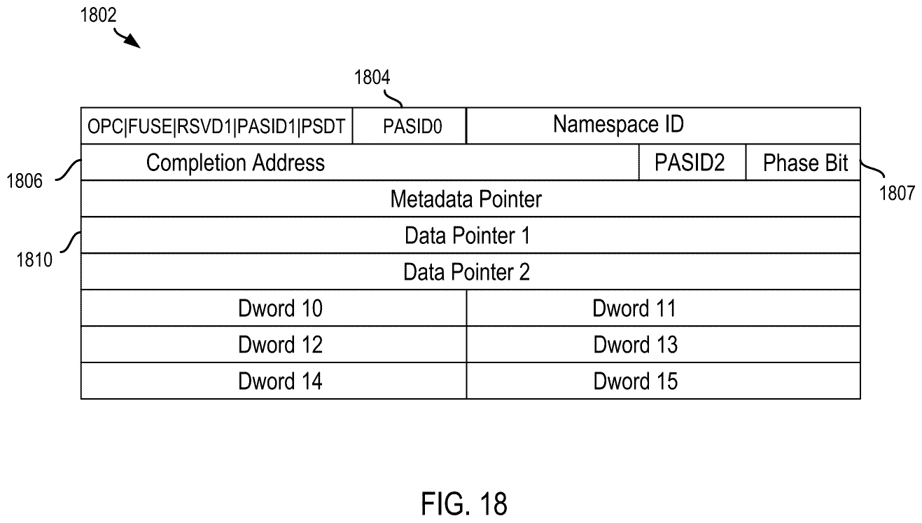

FIG. 18 shows a format 1802 of commands received in a shared work queue according to one embodiment. In one example, format 1802 is used by commands received in shared work queue 222, 320. Format 1802 includes various predefined fields, as illustrated.

Format 1802 includes field 1804 of Dword 0 for at least a first portion (e.g., PASID0) of an address space identifier. Dword 0 also includes a second portion of the address space identifier (e.g., PASID1). In one example, the address space identifier is a PASID. Format 1802 includes fields 1806 and 1807 for a completion address, a third portion of the address space identifier (e.g., PASID2), and a phase bit. Format 1802 also includes various other fields such as field 1810 for a data pointer.

In one embodiment, the fields of format 1802 are identical to the fields of format 1702, except for Dwords 0-3.

In one example, field 1804 is repurposed to use the first portion of the PASID instead of using for a Command ID as in field 1704. Both fields are at the same double word location of the command format. The portion of PASID in field 1804 is an example of a corresponding portion of PASID 1110.

In general, an address space identifier can be split into multiple fields of format 1802. In one example, the 20 bits of a PASID are split into three fields as follows:
PASID0: 16 bits (bits 16 to 31 of Dword 0), contains PASID bits 0 to 15 (NVMe 2.0 specification 16 bits command id).
PASID1: 2bits (bits 12 to 13 of Dword 0), contains PASID bits 16 to 17 (NVMe 2.0 specification bits 12 to 13 of the Reserved field in Dword 0).
PASID2: 2 bits (bits 1 to 2 of Dword 3), contains PASID bits 18 to 19 (NVMe 2.0 specification bits 1 to 2 of Dword 3).

The field “RSVD1” is 2 bits (bits 10 to 11 of Dword 0).

In one embodiment, fields 1806, 1807 replace reserved fields 1706, 1708. Both fields are at the same double word locations of the overall command format. The completion address of field 1806 is an example of completion address 1632.

Field 1807 is for a phase bit. In one embodiment, field 1807 is a single bit in size. The size of field 1807 can vary for other embodiments. For example, field 1807 could include a multi-bit indication 750 in a completion record 740. The phase bit of field 1807 is an example of phase bit 1650.

In some embodiments, certain NVMe commands use Dword 2 and Dword 3 for command specific information needs. Thus, Dword 2 and 3 cannot be used to store the completion address. Consequently, in such cases, these specific commands, if any are issued, are sent using the legacy queue pair (e.g., over a NVMe specification 2.0 queue pair). For example, for certain read and write commands, Dwords 2 and 3 are used for configuration of end-to-end protection.

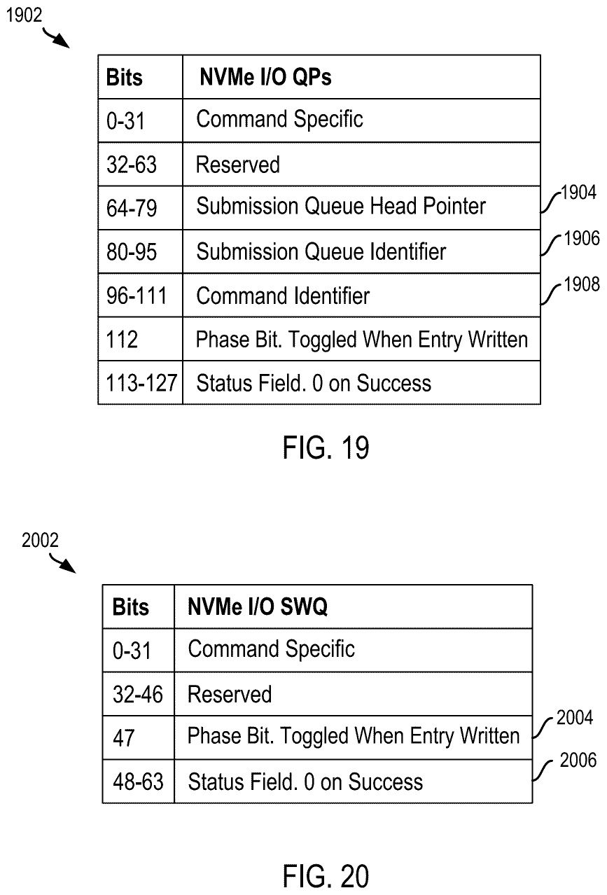

FIG. 19 shows a format 1902 of completion records generated for commands received via a submission queue of a legacy system. Format 1902 includes field 1904 for a submission queue head pointer, field 1906 for a submission queue identifier, and field 1908 for a command identifier. These fields are configured according to the NVMe standard.

FIG. 20 shows a format 2002 of completion records generated for commands received in a shared work queue according to one embodiment. In one example, format 2002 is used for completion records 1660.

Format 2002 includes field 2004 for a final value of a phase bit. In one example, the final value is the value of phase bit 1651 in completion record 1660.

Format 2002 includes field 2006 for status data.

In one embodiment, the size of format 2002 is smaller than the size of format 1902. For example, a completion record according to format 1902 has a size of 16 bytes. A completion record according to format 2002 has a size of eight bytes. Format 2002 can be made smaller because fields 1904, 1906, 1908 are not needed when using a shared work queue interface 113.

In addition, certain bit locations of the legacy completion record format are removed to make the completion record smaller. For example, format 2002 has bits 47-63, which correspond to bits 112-127 of format 1902. Bits 32-63 of format 1902 is a reserved field. A portion of this reserved field is removed to shorten the completion record so that the size of format 2002 is eight bytes.

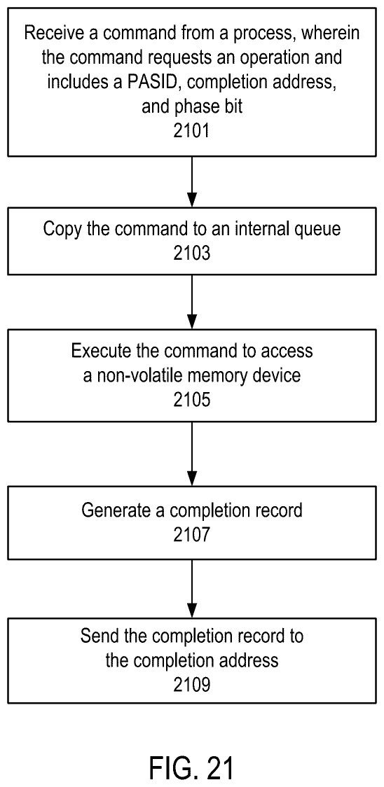

FIG. 21 shows a method for executing a command to access a non-volatile memory device and generating a completion record according to one embodiment. The method of FIG. 21 can be performed by processing logic that can include hardware (e.g., processing device, circuitry, dedicated logic, programmable logic, microcode, hardware of a device, integrated circuit, etc.), software/firmware (e.g., instructions run or executed on a processing device), or a combination thereof. In some embodiments, the method of FIG. 21 is performed at least in part by the processing device 118 of the host system 102, the controller 115 of the memory sub-system 101, and/or the local media controller 105 of the memory sub-system 101 in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

For example, the method of FIG. 21 can be implemented using the shared work queue interfaces 113 of FIG. 1 to perform the operations illustrated in FIGS. 16, 18, 20.

At block 2101 in FIG. 21, a command is received in a shared work queue. The command is from a process on a host system. The command requests an operation. The command includes an address space identifier, completion address, and initial value of a phase bit. In one example, command 1622 is received by shared work queue 222.

At block 2103, the command is copied to an internal command queue. In one example, command 1622 is copied to queue 230.

At block 2105, the command is executed to access a non-volatile memory device. In one example, command 1622 indicates a read operation and data is read from non-volatile memory device 240.

At block 2107, a completion record is generated after the command has been executed. In one example, completion record 1660 is generated in response to completing execution of command 1622.

At block 2109, the completion record is sent to the completion address in memory at the host system. In one example, completion record 1660 is written to address 1632 of memory 204.

In some aspects, the techniques described herein relate to a memory sub-system (e.g., 1602) including: at least one non-volatile memory device; and at least one controller (e.g., 250) configured to: receive, from a submission queue (e.g., 1640), a first command configured with a predefined field, wherein the predefined field includes a command identifier; and receive, in a shared work queue (e.g., 222), a second command from a process executing on a host system (e.g., 1602), wherein the second command is configured with the predefined field (e.g., 1804), and the predefined field includes at least a portion of an identifier for an address space of the host system used by the process.

In some aspects, the techniques described herein relate to a memory sub-system, wherein the controller is further configured to, in response to receiving the second command, execute the second command to access the non-volatile memory device according to an operation identified in the second command.

In some aspects, the techniques described herein relate to a memory sub-system, wherein the predefined field is configured at a same format location of the first and second commands according to a standard for communications between memory sub-systems and host systems.

In some aspects, the techniques described herein relate to a memory sub-system, wherein the standard is a standard for non-volatile memory express (NVMe).

In some aspects, the techniques described herein relate to a memory sub-system, wherein the first command is an administrative command.

In some aspects, the techniques described herein relate to a memory sub-system, wherein the identifier is assigned to the process by an operating system executing on the host system.

In some aspects, the techniques described herein relate to a memory sub-system, wherein the identifier is a process address space ID (PASID) according to a standard for peripheral component interconnect express (PCIe).

In some aspects, the techniques described herein relate to a memory sub-system, wherein the predefined field is a first predefined field, each of the first and second commands is configured with a second predefined field at least partially at a same format location, and the second predefined field (e.g., 1810) includes a data pointer.

In some aspects, the techniques described herein relate to a memory sub-system, wherein the data pointer is configured according to a standard for non-volatile memory express (NVMe).

In some aspects, the techniques described herein relate to a memory sub-system including: at least one non-volatile memory device; and at least one controller configured to: receive, from a submission queue, a first command configured with first and second reserved fields (e.g., 1706, 1708); and receive, in a shared work queue, a second command from a process executing on a host system, wherein the second command is configured with the first and second reserved fields, and the first and second reserved fields include a completion address, at least a portion of a PASID, and a value of a phase bit.

In some aspects, the techniques described herein relate to a memory sub-system, wherein the first and second reserved fields are configured at a same format location in each of the first and second commands according to a standard for communications between memory sub-systems and host systems.

In some aspects, the techniques described herein relate to a memory sub-system, wherein the standard is a standard for non-volatile memory express (NVMe).

In some aspects, the techniques described herein relate to a memory sub-system, wherein the first and second reserved fields are Dword2 and Dword3 of a command format according to the standard.

In some aspects, the techniques described herein relate to a memory sub-system, wherein the first reserved field contains a most significant bit of the completion address, and the phase bit is located at bit 0 of the second reserved field.

In some aspects, the techniques described herein relate to a memory sub-system, wherein the controller is further configured to send a completion record to the completion address using a PASID in the command.

In some aspects, the techniques described herein relate to a memory sub-system, wherein the value for the phase bit is an initial value, and the completion record includes a final value for the phase bit that indicates whether execution of the second command is completed.

In some aspects, the techniques described herein relate to a memory sub-system including: at least one non-volatile memory device; and at least one controller configured to: generate, in response to receiving a first command from a submission queue, a first completion record having first predefined fields, wherein the first predefined fields include a submission queue head pointer, a submission queue identifier, and a command identifier; and generate, in response to receiving a second command in a shared work queue, a second completion record having second predefined fields including a final value of a phase bit (e.g., value of phase bit in field 2004), wherein the second completion record excludes the first predefined fields.

In some aspects, the techniques described herein relate to a memory sub-system, wherein the second command is from a process executing on a host system, and the second command includes a completion address.

In some aspects, the techniques described herein relate to a memory sub-system, wherein the controller is further configured to send the second completion record to the completion address.

In some aspects, the techniques described herein relate to a memory sub-system, wherein the second command includes an initial value of the phase bit.

In some aspects, the techniques described herein relate to a memory sub-system, wherein the second predefined fields further include a status field to indicate a characteristic associated with execution of the second command.

In some aspects, the techniques described herein relate to a memory sub-system, wherein a size of a format for the first completion record is greater than a size of a format for the second completion record.

In some aspects, the techniques described herein relate to a memory sub-system including: at least one non-volatile memory device; and at least one controller configured to: receive, in a shared work queue, a command from a process executing on a host system, wherein the command is configured with predefined fields including an identifier for an address space (e.g., a PASID split into two or fields of the command) of the host system used by the process, and a completion address.

In some aspects, the techniques described herein relate to a memory sub-system, wherein the predefined fields further include a phase bit.

In some aspects, the techniques described herein relate to a memory sub-system, wherein the predefined fields further include a data pointer.

In some aspects, the techniques described herein relate to a memory sub-system, wherein the data pointer is configured according to a standard for non-volatile memory express (NVMe).

In some aspects, the techniques described herein relate to a memory sub-system, wherein the controller is further configured to, in response to receiving the command, copy the command to an internal command queue for execution to access the non-volatile memory device according to an operation identified in the command.

In some aspects, the techniques described herein relate to a memory sub-system, wherein the identified operation is a read or write operation.

In some aspects, the techniques described herein relate to a memory sub-system, wherein the command specifies a memory address to access a memory of the host system to transfer data for a logical block.

In some aspects, the techniques described herein relate to a memory sub-system, wherein the logical block is identified using a logical block addressing (LBA) address.

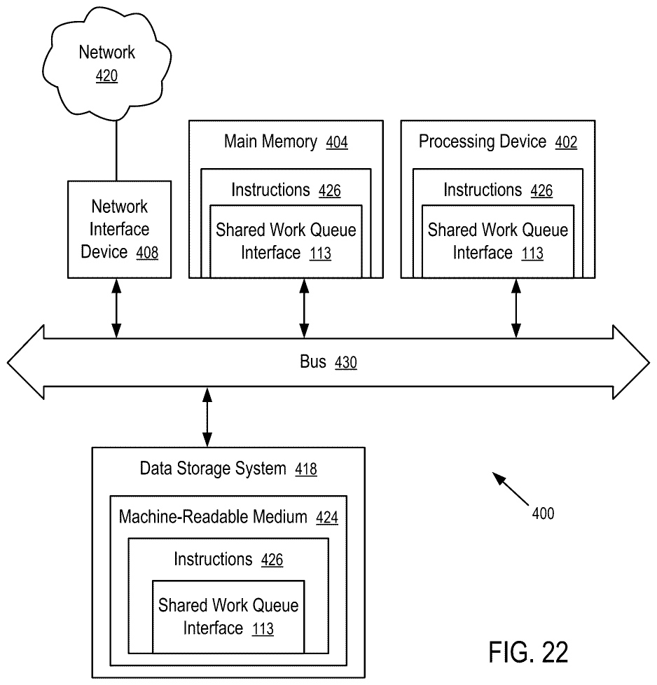

FIG. 22 illustrates an example machine of a computer system 400 within which a set of instructions, for causing the machine to perform any one or more of the methodologies discussed herein, can be executed. In some embodiments, the computer system 400 can correspond to a host system (e.g., the host system 102 of FIG. 1) that includes, is coupled to, or utilizes a memory sub-system (e.g., the memory sub-system 101 of FIG. 1) or can be used to perform the operations of shared work queue interfaces 113 (e.g., to execute instructions to perform operations corresponding to the shared work queue interfaces 113 described with reference to FIGS. 1-21). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), static random access memory (SRAM), etc.), and a data storage system 418, which communicate with each other via a bus 430 (which can include multiple buses).

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable medium 424, data storage system 418, and/or main memory 404 can correspond to the memory sub-system 101 of FIG. 1.

In one embodiment, the instructions 426 include instructions to implement functionality corresponding to the shared work queue interfaces 113 described with reference to FIGS. 1-21. While the machine-readable medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

1. A memory sub-system comprising:
at least one non-volatile memory device; and
at least one controller configured to:
receive, from a submission queue, a first command configured with a predefined field, wherein the predefined field includes a command identifier; and
receive, in a shared work queue, a second command from a process executing on a host system, wherein the second command is configured with the predefined field, and the predefined field includes at least a portion of an identifier for an address space of the host system used by the process.

2. The memory sub-system of claim 1, wherein the controller is further configured to, in response to receiving the second command, execute the second command to access the non-volatile memory device according to an operation identified in the second command.

3. The memory sub-system of claim 1, wherein the predefined field is configured at a same format location of the first and second commands according to a standard for communications between memory sub-systems and host systems.

4. The memory sub-system of claim 3, wherein the standard is a standard for non-volatile memory express (NVMe).

5. The memory sub-system of claim 1, wherein the first command is an administrative command.

6. The memory sub-system of claim 1, wherein the identifier is assigned to the process by an operating system executing on the host system.

7. The memory sub-system of claim 1, wherein the identifier is a process address space ID (PASID) according to a standard for peripheral component interconnect express (PCIe).

8. The memory sub-system of claim 1, wherein the predefined field is a first predefined field, each of the first and second commands is configured with a second predefined field at a same format location, and the second predefined field includes a data pointer.

9. The memory sub-system of claim 8, wherein the data pointer is configured according to a standard for non-volatile memory express (NVMe).

10. A memory sub-system comprising:
at least one non-volatile memory device; and
at least one controller configured to:
receive, from a submission queue, a first command configured with first and second reserved fields; and
receive, in a shared work queue, a second command from a process executing on a host system, wherein the second command is configured with the first and second reserved fields, and the first and second reserved fields include a completion address, a portion of an address space identifier, and a value of a phase bit.

11. The memory sub-system of claim 10, wherein the first and second reserved fields are configured at a same format location in each of the first and second commands according to a standard for communications between memory sub-systems and host systems.

12. The memory sub-system of claim 11, wherein the standard is a standard for non-volatile memory express (NVMe).

13. The memory sub-system of claim 12, wherein the first and second reserved fields are Dword2 and Dword3 of a command format according to the standard.

14. The memory sub-system of claim 10, wherein the first reserved field contains a most significant bit of the completion address, and the phase bit is located at bit 0 of the second reserved field.

15. The memory sub-system of claim 10, wherein the controller is further configured to send a completion record to the completion address.

16. The memory sub-system of claim 15, wherein the value for the phase bit is an initial value, and the completion record includes a final value for the phase bit that indicates whether execution of the second command is completed.

17. A memory sub-system comprising:
at least one non-volatile memory device; and
at least one controller configured to:
generate, in response to receiving a first command from a submission queue, a first completion record having first predefined fields, wherein the first predefined fields include a submission queue head pointer, a submission queue identifier, and a command identifier; and
generate, in response to receiving a second command in a shared work queue, a second completion record having second predefined fields including a final value of a phase bit, wherein the second completion record excludes the first predefined fields.

18. The memory sub-system of claim 17, wherein the second command is from a process executing on a host system, and the second command includes a completion address.

19. The memory sub-system of claim 18, wherein the controller is further configured to send the second completion record to the completion address.

20. The memory sub-system of claim 17, wherein the second command includes an initial value of the phase bit.

21. The memory sub-system of claim 17, wherein the second predefined fields further include a status field to indicate a characteristic associated with execution of the second command.

22. The memory sub-system of claim 17, wherein a size of a format for the first completion record is greater than a size of a format for the second completion record.

23. A memory sub-system comprising:
at least one non-volatile memory device; and
at least one controller configured to:
receive, in a shared work queue, a command from a process executing on a host system, wherein the command is configured with predefined fields including an identifier for an address space of the host system used by the process, and a completion address.

24. The memory sub-system of claim 23, wherein the predefined fields further include a phase bit.

25. The memory sub-system of claim 24, wherein the predefined fields further include a data pointer.

26. The memory sub-system of claim 25, wherein the data pointer is configured according to a standard for non-volatile memory express (NVMe).

27. The memory sub-system of claim 23, wherein the controller is further configured to, in response to receiving the command, copy the command to an internal command queue for execution to access the non-volatile memory device according to an operation identified in the command.

28. The memory sub-system of claim 27, wherein the identified operation is a read or write operation.

29. The memory sub-system of claim 23, wherein the command specifies a memory address to access a memory of the host system to transfer data for a logical block.

30. The memory sub-system of claim 29, wherein the logical block is identified using a logical block addressing (LBA) address.
